(19) United States
(12) Patent Application Publication
(10) Pub. No.: US 2025/0287440 A1
(43) Pub. Date: Sep. 11, 2025

(54) Systems and Methods for RAN Protocol for Future X-centric Service Network

(71) Applicant: HUAWEI TECHNOLOGIES CO., LTD., Shenzhen (CN)

(72) Inventors: Chenchen YANG, Guangdong (CN); Xu LI, Kanata (CA); Weisen SHI, Kanata (CA); Bidi YING, Kanata (CA)

(73) Assignee: HUAWEI TECHNOLOGIES CO., LTD., Shenzhen (CN)

(21) Appl. No.: 19/213,378

(22) Filed: May 20, 2025

Related U.S. Application Data
(63) Continuation of application No. PCT/CN2022/134727, filed on Nov. 28, 2022.

(51) Int. Cl. H04W 76/12; H04W 12/12; H04W 28/24; H04W 76/40

(52) U.S. Cl. CPC H04W 76/12; H04W 12/12; H04W 28/24; H04W 76/40

(57) ABSTRACT

The disclosure provides for systems and methods for a radio access network (RAN) protocol for future X-centric service network. According to an aspect, a method for providing a network service is provided. The method includes receiving, by a first device from a second device, at least one protocol data unit (PDU) containing at least one service data unit (SDU) associated with the network service. The method further includes retrieving, by the first device, the at least one SDU from the at least one PDU. The method further includes processing, by the first device, the at least one SDU to obtain a processed version of the at least one SDU. The method further includes constructing, by the first device, at least one additional PDU comprising the processed version of the at least one SDU. The method further includes sending, by the first device to the second device, the at least one additional PDU.

### CROSS-REFERENCE TO RELATED APPLICATION

This application is a continuation of International Application No. PCT/CN2022/134727, filed on Nov. 28, 2022, the disclosure of which is hereby incorporated by reference in its entirety.

### TECHNICAL FIELD

The present disclosure pertains to the field of communication networks, and in particular to systems and methods for RAN protocols in X-centric service network.

### BACKGROUND

Besides the traditional connectivity-oriented communication services, sixth generation (6G) wireless networks may include new kinds of services for network-native data processing. Such new services may require data parsing and processing within a network, which may not be supported in the current 5G wireless networks. For example, the current 5G wireless networks may have limitations on what operations may be performed within the network which may reduce the availability and provision of the new kinds of services that may be included in 6G wireless networks. Some limitations of the 5G wireless networks may include limited operations that may performed by the radio access network (RAN) and at the different layers of the user plane (UP) protocol stack.

Therefore, there is a need for systems and methods for a RAN protocol for future X-centric service network that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

The disclosure provides for systems and methods for a RAN protocol for future X-centric service network. According to an aspect a method for providing a network service is provided. The method includes receiving, by a first device from a second device, at least one protocol data unit (PDU) containing at least one service data unit (SDU) associated with the network service. The method further includes retrieving, by the first device, the at least one SDU from the at least one PDU. The method further includes processing, by the first device, the at least one SDU to obtain a processed version of the at least one SDU. The method further includes constructing, by the first device, at least one additional PDU comprising the processed version of the at least one SDU. The method further includes sending, by the first device to the second device, the at least one additional PDU.

The first device can be a radio access network (RAN) node, the second device can be a user equipment (UE), or the first device can be a UE, the second device can be a RAN node.

The first device can be a radio access network (RAN) node, the second device can be a core network function (CNF).

The first device can be a CNF, the second device can be a RAN node.

The first device can be a CNF, the second device can be a UE.

The first device can be a UE, the second device can be a CNF.

Retrieving the at least one SDU, processing the at least one SDU, and constructing the at least one additional PDU may be performed at the first device, by a processing function (PF) at the first device.

Receiving the at least one PDU at the first device may include receiving the at least one PDU via at least one network service data bearer (XDB) established between the first device and the second device, the at least one XDB being configured for the network service.

The method may be performed in a communication network in which the first device and the seccond device are deployed. The communication network may include a PF protocol sublayer. The retrieving of the at least one SDU, the processing of the at least one SDU and the constructing of the at least one additional PDU at the first device may be performed in the PF protocol sublayer, by PF at the first device.

The UE may include a UE PF deployed at the UE in the PF protocol sublayer. Receiving, from the UE, the at least one PDU may include receiving the at least one PDU from the UE PF via at least one network service data bearer (XDB) established between the first device and the second device. The at least one XDB may be supported by the PF protocol sublayer.

The network service may include one or more of: data analytics, artificial intelligence (AI) training, AI inference, data privacy protection, data sanitization, data processing, data management, data cleaning, data normalization, useless data filtering, data feature engineering, data compression, data embedding, data representation learning, and data feature extraction.

The communication network may further include a packet data convergence protocol (PDCP) sublayer, the PF protocol sublayer being deployed on top of the PDCP sublayer.

The communication network may further include a service data adaptation protocol (SDAP) sublayer, the PF protocol sublayer being deployed below the SDAP sublayer.

The PDCP sublayer may provide at least one data radio bearer (DRB) to the PF protocol sublayer, between the first device and the second device.

The PF protocol sublayer may provide the at least one network service data bearer (XDB) to the SDAP sublayer.

The communication network may include a radio link control (RLC) sublayer, a medium access control (MAC) sublayer and a physical (PHY) layer, the PDCP sublayer being on top of the RLC sublayer, the MAC sublayer and the PHY layer.

Each of the at least one XDB may have a respective PF entity in the PF protocol sublayer, each PF entity being configured for a respective XDB.

The PDCP sublayer may include, for each of the at least one DRB, a respective PDCP entity in the PDCP sublayer.

The SDAP sublayer may comprise an SDAP entity configured for at least one session of the network service. Any of the at least one session of the network service may be established between the UE and a core network function (CNF). The method may further include establishing a CN session tunnel between the RAN node and the CNF.

Any of the at least one session of the network service may include at least one quality-of-service (QoS) flow of the network service, a single QoS flow of the at least one QoS flow of the network service being of a finest granularity of QoS differentiation in a session of the at least one session of the network service. A traffic in a same one of the at least one QoS flow of the network service receives a same data forwarding treatment and data processing treatment.

Parameters of the data processing treatment may include one or more of: a data processing scheduling policy, a data computing accuracy, a data computing latency, an artificial intelligence (AI) model type, an AI model privacy level, an AI model accuracy level, an AI training method, an AI inference method, a privacy protection method, a data management policy, a data sanitization policy, a data compression policy, a data embedding policy, a data representation learning policy, a data feature extraction policy, a data preprocessing policy, a privacy level, a data storage duration, a data processing policy, a data cleaning policy, a data normalization policy, a data quality level, and a data processing priority.

Parameters of the data forwarding treatment parameters may include one or more of: a data transfer resource scheduling policy, a data queue management policy, a data transfer priority level, a link layer protocol configuration, an admission threshold, a data loss rate, a data transfer latency, a data forwarding security protection method, and a security level.

The at least one XDB may be configured to serve the UE only. The at least one XDB may further be configured to deliver to the UE and to receive from the UE, PF protocol sublayer PDUs over a radio interface.

The UE is configured with the at least one XDB. One or multiple PF entities of the at least one XDB are connected with one or multiple PDCP entities dedicated for the UE.

The at least one XDBs of the UE may be mapped to one or multiple DRBs of the same UE. The at least one session of the network service may be mapped by the SDAP entity to the at least one XDB dedicated for the UE.

The at least one QoS flow of the at least one session of the network service may be mapped by the SDAP entity to the at least one XDB dedicated for the UE.

The at least one XDB may be configured for a group of UEs to deliver PF protocol sublayer PDUs to the group of UEs including the UE, to deliver at least one PF protocol sublayer PDU to the group of UEs and to receive the at least one PF protocol sublayer PDU from the group of UEs.

The at least one XDB may deliver a copy of the at least one PF protocol sublayer PDU over a radio interface to the group of UEs using one of a broadcast method and a multicast method. The UE of the group of UEs may be configured with the at least one XDB.

At least one PF entity of the at least one XDB for the group of UEs may be connected with at least one PDCP entity for the group of UEs. The at least one PDCP entity may be configured for one Multimedia Broadcast Multicast Service (MBMS) point to multipoint radio bearer (MRB). The at least one PDCP entity may be configured for a point to multipoint radio bearer (NRB).

The at least one session of the network service may be mapped by the SDAP entity to the at least one XDBs of the group of UEs.

The at least one QoS flow of the at least one session of the network service may be mapped by the SDAP entity to the at least one XDBs of the group of UEs.

The at least one XDB may deliver, over a radio interface to different US of the group of UEs different PF protocol sublayer PDUs, or separate copies of PF protocol sublayer PDUs. The group of UEs may be configured with the at least one XDB.

The at least one PF entity of the at least one XDB for the group of UEs may be connected to at lease one PDCP entity. Any of the at least one PDCP entity may be configured for at least one UE in the group of UEs. Any of the at least one PDCP entity may be connected to at least one link control (RLC) entity. Any of the at least one PDCP entity may be configured for one or more of: a DRB, a multicast/broadcast services radio bearer (MRB), a point to multipoint radio bearer (NRB).

The at least one session of the network service may be mapped by an SDAP entity to the at least one XDB of the group of UEs. At least one QoS flow of at least one session of the network service may be mapped by an SDAP entity in the SDAP sublayer to the at least one XDB of the group of UEs.

The PF protocol sublayer may include a PF entity. The PF entity may include one or more of: a data buffer component, a data processing component, a routing component, and a data transfer component.

The data buffer component may be configured to perform one or more of: storing data, buffering data, accumulating data for the data processing component to perform data processing.

The data processing component may be configured to execute data processing with one or more methods of: data analytics, artificial intelligence (AI) training, AI inference, data privacy protection, data sanitization, data processing, data management, data cleaning, data normalization, useless data filtering, data feature engineering, data compression, data embedding, data representation learning, and data feature extraction.

The routing component of the PF entity may be configured to add routing information to a header of a PF PDU to help another PF entity to decide routing actions. The routing component may further be configured to decide the routing actions of the PF entity based on the routing information included in the header of the PF PDU.

The routing actions of the PF entity or the routing actions of the another entity may include one or more of: stopping data transfer, transferring data to a PF entity residing in a same node with the PF entity, transferring data to a PF entity residing in a same node with the another PF entity, transferring data to a PF entity of a peer node, transferring data to an entity of an upper layer, or transferring data to an entity of a lower layer, wherein the data includes one or more of: a PF SDU contained in the PF PDU, a processed version of the PF SDU contained in the PF PDU, a constructed PF PDU comprising the PF SDU contained in the PF PDU, or a constructed PF PDU comprising the processed version of the PF SDU contained in the PF PDU.

The data transfer component may be configured to execute with respect to data one or more of: mapping or delivering of the data to a corresponding transmission tunnel or channel, performing sequence numbering of the data, and sequentially delivering the data to the PF protocol sublayer, the upper layer, or the lower layer.

The PF entity may perform one or more of: receiving or delivering at least one PF SDU from or to an upper layer. The PF entity may perform one or more of: receiving or delivering the at least one PF SDU from or to a lower layer. The PF entity may perform one or more of: receiving or delivering the at least one PF SDU from or to another PF entity. The PF entity may perform one or more of: submitting or receiving at least one PF PDU to or from the lower layer. The PF entity may perform one or more of: submitting or receiving at least one PF PDU to or from the another entity. The at least one PF PDU may include one or more of: a packet header and a PF SDU.

One PF PDU of the at least one PF PDU may include a packet header indicating one or more of: a type of the network service the one PF PDU belongs to, a sequence number of the one PF PDU, an indication to further process the one PF SDU contained in the one PF PDU, a type of data processing on the one PF SDU contained in the one PF PDU, an indication to forward a PF SDU contained in the one PF PDU directly, a routing information, a network service QFI identifying the QoS flow to which the one PF PDU belongs.

The type of data processing may include one or more methods of: data analytics, AI training, AI inference, data privacy protection, data sanitization, data processing, data management, data cleaning, data normalization, useless data filtering, data feature engineering, data compression, data embedding, data representation learning, and data feature extraction.

The routing information may indicate a destination for a PF entity receiving the PF PDU to transfer the data to, and the data includes one or more of: the PF SDU contained in the PF PDU, the processed version of the PF SDU contained in the PF PDU, a constructed PF PDU including the PF SDU contained in the PF PDU, or a constructed PF PDU comprising the processed version of the PF SDU contained in the PF PDU.

The destination may be one or more of: the PF entity, another PF entity residing in the same node with the PF entity, another PF entity of a peer node, an entity of an upper layer, or an entity of a lower layer.

Retrieving the at least one SDU from the at least one PDU may include retrieving the at least one PF SDU by the PF entity from the at least one PF PDU. Retrieving the at least one PF SDU from the at least one PF PDU may further include removing one or multiple packet headers contained in the at least one PF PDU.

Constructing the at least one additional PF PDU may be performed by the PF entity after retrieving the at least one PF SDU from the at least one PF PDU. Constructing the at least one additional PDU may include one or more of: parsing and processing raw data encapsulated in one or multiple payload of the at least one PF SDU with one or more methods of: data analytics, AI training, Al inference, data privacy protection, data sanitization, data processing, data management, data cleaning, data normalization, useless data filtering, data feature engineering, data compression, data embedding, data representation learning, and data feature extraction.

For the at least one XDB of the network service, a dedicated type of one or more of: an associated DRB, an RLC channel, a logical channel, a transport channel, and a physical channel may be defined, reserved, or configured. Similarly, a dedicated physical radio resource may be allocated to the at least one XDB of the network service.

The at least one XDB and the associated DRB may be configured with a same MAC entity of an associated MAC sublayer to multiplex related radio resources.

The at least one XDB may be configured via a dedicated signalling message for the network service or a radio resource control (RRC) message for the network service. The dedicated signaling message for the network service may be sent via a signaling radio bearer between the RAN node and the UE by a control entity of a control protocol layer above an associated PDCP sublayer.

The PF entity may include one or more of: a transmitting part and a receiving part, each of the transmitting part and the receiving part to perform one or more functions of a the PF entity.

The PF protocol sublayer may be configured at one or more of the RAN node and the UE node. The PF protocol sublayer may operate in a transparent mode when the RAN node is to perform data-forwarding.

The PF protocol sublayer may be configured at the RAN node and the UE without configuring session tunnels between the RAN node and a CNF. The network service may involve the RAN node and the UE without involving the CNF.

The PF protocol sublayer may be configured at the RAN node without configuring an SDAP sublayer, radio L2 sublayers and PHY layer at the RAN node. The network service may involve the RAN node and a CNF without involving the UE.

Sublayers including the SDAP sublayer, the PF protocol sublayer, the associated PDCP sublayer, an associated RLC sublayer, an associated MAC sublayer, and an associated PHY layer may be configured at the RAN node and at the UE. A session tunnel between a CNF and the RAN node may be configured, when the network service involves the RAN node, the UE, and the CNF.

The RAN node, the UE and the CNF may be configured without the SDAP sublayer. Traffic granularity of QoS flow of the network service may be the same as that of the at least one XDB.

A CNF PF entity may be configured in an associated PF protocol layer at a CNF node. The CNF PF entity may perform at least one function of: a RAN PF entity at the RAN node and a UE PF entity at the UE.

The FP sublayer may be deployed at one of: on top of the PDCP sublayer, between the SDAP sublayer and the PDCP sublayer, between the PDCP sublayer and the RLC sublayer, between the RLC sublayer and the MAC sublayer, between the MAC sublayer and PHY layer, on top of the SDAP sublayer, on top of a PDU layer, on top of a GTP-U layer, on top of UDP layer, on top of an IP layer, on top of a QUIC layer, on top of a Hypertext Transfer Protocol (HTTP) layer, on top of a segment routing over IPv6 (SRv6) layer, within the PDU layer, within the SDAP sublayer, within the PDCP sublayer, within the RLC sublayer, within the MAC sublayer, within the PHY layer, within the GTP-U layer, within the UDP layer, within the IP layer, within the application layer, within HTTP layer, within SRv6 layer, and within the QUIC layer.

Traffic in a same XDB of the at least one SDB may receive a same data forwarding treatment and data processing treatment, where one or more data processing treatment parameters and data forwarding treatment parameters are configured per XDB of the at least one XDB.

According to another aspect, another method is provided. The method includes receiving, by a radio access network (RAN) node from user equipment (UE), a first message including service data units (SDUs) associated with a network service. The method further includes retrieving, by the RAN node, the SDUs from the first message. The method further includes sending, by the RAN node to the UE, a second message based on the SDUs.

The first message may include a quality-of-service flow identifier QFI. The method may further includes sending, by the RAN node to a core network (CN) function (CNF), a third message via a session established between the UE and the CNF, the third message including the SDUs. The method may further includes receiving, by the RAN node from the CNF, via the session, a fourth message comprising a processed version of the SDUs obtained based on a processing treatment indicated by the QFI.

The QFI may indicate a processing treatment, and the method may further include processing, by the RAN node, the SDUs according to the processing treatment to obtain a processed version of the SDUs.

The method may further include constructing, by the RAN node, a set of packet data units (PDUs) comprising the processed version of the SDUs, and wherein the second message comprises the set of PDUs.

At least one PDU of the set of PDUs may include a header indicating one or more of: a type of the network service, a sequence number, an indication to determine whether further processing is needed, an indication to forward the PDU directly; a routing information, the QFI to which the PDU belongs.

Receiving the message, retrieving the SDUs, and constructing the set of PDUs may be performed by a processing function at the RAN node.

The first message may be received via a data bearer established between the RAN node and the UE, the data bearer being configured for the network service. The data bearer may be configured via an RRC message or a signaling message received from a control plane function.

The data bearer may be a dedicated data bearer for the UE. The UE may be part of a UE group and the data bearer may be configured for the UE group. The data bearer may be mapped to one or more of multicast/broadcast service (MBS) radio bearers (MRBs).

Sending, by the RAN node to the UE, a second message may include sending, by the RAN node to each UE in the UE group, the second message via MRB.

The network service may be a NET4AI service, and the first message may indicate local model parameters of the UE. Where the network service is a NET4AI, retrieving the SDUs from the message comprises: retrieving, by the RAN node, the local model parameters.

Where the first message includes a QFI, the method may further include aggregating, by the RAN node, local model parameters of multiple UEs including the UE based on a processing treatment indicated by the QFI. The method may further include obtaining, by the RAN node, global model parameters based on the aggregating and the processing treatment.

The method may further include sending, by the RAN node to a core network (CN) function (CNF), a third message via a session established between the UE and the CNF, the third message comprising the local model parameters. The method may further include receiving, by the RAN node from the CNF, a fourth message comprising global local parameters determined based on local model parameters of multiple UEs including the UE.

The method may further include constructing, by the RAN node, a set of PDUs comprising the global local parameters, and wherein the second message comprises the set of PDUs.

The network service may be a DAM service and the first message may indicate output of an adversarial model based on a training the adversarial model. Where the network service may be a DAM service, retrieving the SDUs from the first message may include: retrieving, by the RAN node, the output of the adversarial model.

Where the network service may be a DAM service, and the first message may include a QFI, the method may further include training, by the RAN node, a generative model using the output of the adversarial model based on a processing treatment indicated by the QFI. The method may further includes obtaining, by the RAN node, an output of generative model based on the training and the processing treatment.

Where the network service may be a DAM service, the method may further include sending, by the RAN node to a core network (CN) function (CNF), a third message via a session established between the UE and the CNF, the third message comprising the output of the adversarial model. The method may further include receiving, by the RAN node from the CNF, a fourth message comprising output of a generative model trained based at least in part on the output of the adversarial model.

Where the network service may be a DAM service, the method may further include constructing, by the RAN node, a set of PDUs comprising the output of a generative model, wherein the second message comprises the set of PDUs.

According to another aspect, another method is provided. The method includes receiving, by a radio access network (RAN) node from a network node (NN), a first message comprising data associated with a network service. The method may further include processing, by the RAN node, the data according to the network service to obtain a processed version of the data. The method may further include sending, by the RAN node to a second NN, a message comprising the processed version of the data.

The NN may be one of: a core network (CN) function (CNF), a second RAN node, and a user equipment (UE). The second NN may be one of: the CNF, a second CNF, a second RAN node, a third RAN node, the UE, and a second UE.

The method may further include retrieving, by the RAN node, the data comprising a first set of service data units (SDUs); and wherein processing the data comprising processing the first set of SDUs.

According to another aspect, another method is provided. The method includes receiving, by a receiving processing function (PF) at a network node (NN), one or more protocol data units (PDUs) associated with a network service from a transmitting PF at a second NN. The method may further include retrieving, by the receiving PF at the NN, one or more service data units (SDUs) from the PDUs. The method may further include sending, by the receiving PF at the NN, the one or more SDUs to one of: a transmitting PF at the NN, and an upper layer of the NN.

The method may further include processing, by the receiving PF at the NN, the one or more SDUs to obtain processed SDUs, the processing performed according to a data processing treatment associated with a quality of service (QOS) requirement. The sending the one or more SDUs includes sending the processed SDUs.

The method may further include buffering, by the receiving PF at the NN, the retrieved one or more PDUs.

The method may further include sequence numbering, by the receiving PF at the NN, the one or more SDUs. Sending the one or more SDUs includes: sending the one or more SDUs according to the sequence numbering.

The one or more SDUs may be sent according to a routing information, wherein the routing information is determined by one of: a configuration at the receiving PF at the NN, a header of the one or more PDUs, and the receiving PF at the NN via generating the routing information.

The NN may be a radio access network (RAN) node and the second NN may be one of: a user equipment (UE), and a second (RAN) node.

Receiving PF at the NN may be configured by one of: RRC signaling or a signaling message. At least one of the one or more PDUs may include a header indicating one or more of: a type of service, a sequence number, an indication for determining whether further processing is needed, an indication to forward the PDU directly; a routing information, a quality of service (QOS) flow identifier (ID) to which the PDU belongs.

The second NN may be a UE; and the one or more PDUs may be received via a data bearer established between the RAN node and the UE.

The data bearer may be configured via an RRC message or a signaling message received from a control plane function. The data bearer may be a dedicated data bearer for the UE. The UE may be part of a UE group and the data bearer may be configured for the UE group.

The data bearer may be mapped to one or more of multicast/broadcast service (MBS) radio bearers (MRB). The one or more PDUS may be received via the one or more MRB.

According to another aspect, another method is provided. The method includes receiving, by a transmitting processing function (PF) at a network node (NN), one or more SDUs associated with a network service. The method may further include constructing, by the transmitting PF at the NN, one or more protocol data units (PDUs) corresponding to the one or more SDUs. The method may further include sending, by the transmitting PF at the NN, the one or more PDUs to a receiving PF at a second NN.

The method may further include buffering, by the transmitting PF at the NN, the one or more SDUs for further processing. The method may further include processing, by the transmitting PF at the NN, the one or more SDUs to obtained processed SDUs, the processing performed according to a data processing treatment associated with a quality of service (QOS) requirement. The one or more PDUs may include the processed SDUs.

The method may further include sequence numbering, by the transmitting PF at the NN, the one or more PDUs. Sending the one or more PDUs may include: sending the one or more PDUs according to the sequence number.

The method may further include adding, routing information, to a header of the one or more PDUs. The routing information may be determined by one of: a configuration at the transmitting PF at the NN, and the transmitting PF at the NN via generating the routing information.

The NN may be a radio access network (RAN) node. The one or more SDUs may be received from one of: a receiving PF at the NN and an upper layer of the NN.

The transmitting PF at the NN may be configured by one of: RRC signaling or a signaling message.

At least one of the one or more PUD comprises a header indicating one or more of: a type of service, a sequence number, an indication for determining whether further processing is needed, an indication to forward the PDU directly; a routing information, a quality of service (QoS) flow identifier (ID) to which the PDU belongs.

The second NN may be a user equipment (user equipment), the one or more PDUs may be sent via a data bearer established between the RAN node and the UE.

The data bearer may be configured via an RRC message or a signaling message received from a control plane function. The data bearer may be a dedicated data bearer for the UE. The UE is part of a UE group, and the data bearer is configured for the UE group.

The data bearer is mapped to one or more of multicast/broadcast service (MBS) radio bearers (MRB). The one or more PDUS may be sent via the one or more MRB.

According to another aspect, another method for providing a network service in a network is provided. The network may comprise a first network element and a second network element. The method may be performed by the first network element. The method includes obtaining service data units (SDUs). The method further includes generating protocol data units (PDUs) comprising the SDUs. The method further includes providing the PDUs to the second clement. The first element may be one of a user equipment (UE) and a radio access network (RAN) node. The second element may be the other of the UE and the RAN node

According to another aspect, an apparatus is provided. The apparatus includes modules configured to perform one or more of the methods and systems described herein.

According to one aspect, an apparatus is provided, where the apparatus includes: a memory, configured to store a program; a processor, configured to execute the program stored in the memory, and when the program stored in the memory is executed, the processor is configured to perform one or more of the methods and systems described herein.

According to another aspect, a computer readable medium is provided, where the computer readable medium stores program code executed by a device and the program code is used to perform one or more of the methods and systems described herein.

According to one aspect, a chip is provided, where the chip includes a processor and a data interface, and the processor reads, by using the data interface, an instruction stored in a memory, to perform one or more of the methods and systems described herein.

Other aspects of the disclosure provide for apparatus, and systems configured to implement the methods according to the first aspect disclosed herein. For example, wireless stations and access points can be configured with machine readable memory containing instructions, which when executed by the processors of these devices, configures the device to perform one or more of the methods and systems described herein.

Embodiments have been described above in conjunction with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

Further features and advantages of the present invention will become apparent from the following detailed description, taken in combination with the appended drawings, in which:

FIG. 1 illustrates a user plane protocol stack between a user equipment (UE) and a user plane function (UPF).

FIG. 2 illustrates a user plane protocol stack between a UE and a radio access network (RAN).

FIG. 3 illustrates an enhanced UP protocol stack between a UE and a RAN, according to an aspect.

FIG. 4 illustrates XaaS bearers in 6G, according to an aspect.

FIG. 5 illustrates 6G data treatment, according to an aspect.

FIG. 6 illustrates dynamic configuration for different cases, according to an aspect.

FIG. 7 illustrates a functional view of a PF sublayer, according to an aspect.

FIG. 8 illustrates another functional view of a PF sublayer, according to an aspect.

FIG. 9 illustrates data path in a PF sublayer, according to an aspect.

FIG. 10 illustrates a procedure of an XaaS task of PF sublayer, involving, according to an aspect.

FIG. 11 illustrates a structural view of a PF sublayer, according to an aspect.

FIG. 12 illustrates a data flow, according to an aspect.

FIG. 13 illustrates a format of PF PDU according to an aspect.

FIG. 14 illustrates a table indicating description of an Xs field, according to an aspect.

FIG. 15 illustrates a table indicating description a P/F field, according to an aspect.

FIG. 16 illustrates a DL layer 2 architecture for XaaS and PDU connectivity service, according to an aspect.

FIG. 17 illustrates a model of a PF entity comprising a transmitting part (Tx-part) and a receiving part (Rx-part), according to an aspect.

FIG. 18 illustrates another a PF entity comprising a Tx-part and a Rx-part, according to an aspect.

FIG. 19 illustrates a Service Data Adaptation Protocol (SDAP) protocol data unit (PDU) format with an XaaS quality of service flow identifier (XQFI) field in SDAP header, according to an aspect.

FIG. 20 illustrates another DL layer 2 architecture 2060 for PDU connectivity service, according to an aspect.

FIG. 21 illustrates an apparatus that may perform any or all of operations of the above methods and features explicitly or implicitly described herein, according to different aspects of the present disclosure.

It will be noted that throughout the appended drawings, like features are identified by like reference numerals.

### DETAILED DESCRIPTION

The disclosure provides for systems and methods for a RAN protocol for future X-centric service network. According to an aspect, an enhanced RAN node, comprising one or more processing functions, is provided which may allow for operations to be performed at the RAN node, in addition to existing data forwarding functionalities. For example, the RAN node, via its one or more processing functions, may parse and process data, among other functions as described in one or more aspects herein. According to an aspect, an enhanced user plan protocol stack may be provided to support the enhanced RAN node and the one or more processing functions therein. According to another aspect, enhanced bearers may be provided for further supporting the functionalities of the enhanced RAN node.

According to an aspect a method is provided. The method includes receiving, by a radio access network (RAN) node from user equipment (UE), a data traffic associated with a network service and having a quality-of-service flow identifier (QFI). The QFI may indicate a processing treatment for the associated traffic. The method further includes retrieving, by the RAN node, a first set of service data units (SDUs) from the data traffic. The method further includes sending, by the RAN node to the UE, a second data traffic based at least in part on the first set of SDUs. The method may further include constructing, by the RAN node, a set of PDUs comprising the processed version of first set of SDUs, and wherein the second data traffic comprises the set of PDUs.

The method may further include processing, by the RAN node, the first set of SDUs according to the processing treatment to obtain a processed version of the first set of SDUs. The method may further include constructing, by the RAN node, a set of PDUs comprising the processed version of first set of SDUs, and wherein the second data traffic comprises the set of PDUs. The method may enhance a RAN node's functionality and thereby improve availability and provision of 6G services.

Besides the traditional connectivity-oriented communication services, 6G includes new kinds of services for network-native data processing, e.g., data analytics, artificial intelligence (AI) training, AI inference, data privacy protection, data storage, data cleaning, data normalization, useless data filtering, and data feature engineering.

X-centric network may be proposed for 6G to provide X as a service (XaaS). In some aspects, XaaS may be Data Analytics and Management (DAM) as a service, NET4AI as a service, NET4Data as a service, NET4meta as a service, etc. In some aspects, these services can be provided by one or multiple service providers. The one or more services provider my include one or more of: operators, vendors, network functions, network equipment and third parties.

In an aspect, DAM service may include, collecting (by one or more service providers) data from a data source and providing the collected data to a data consumer in a privacy-protected form (e.g., de-identified data, or anonymized data or the like). The data consumer may use the collected data to perform tasks such as data analytics, AI training and AI inference.

In some aspects, NET4AI service may include providing connection and intelligent computing service, e.g., for AI training, and AI inference. In some aspects, NET4Data service may include providing data storage service and performing data access control. In some aspects, two or more of these services may be combined and provided to a customer. For combined services, one or more services providers may cooperate with each other in providing the combined service.

Each XaaS may involve one or more functions in providing the service. In some aspects, each XaaS may involve a service controller (XC). The XaaS XC (or XC) may control and manage the service. For example, XC may control and configure an XaaS processing function (PF) to execute specific tasks involved in an XaaS.

In some aspects, each XaaS may further involve one or more PFs. The XaaS PF (or PF) may execute one or more XaaS tasks under the control of XC. Some examples of XaaS tasks may include data pre-processing & data privacy protection tasks in DAM service, AI training & AI inference tasks in NET4AI service, data storage & access control tasks in NET4Data service.

In some aspects, each XaaS may be provided by an XaaS module. Each module may be associated with an XC and one or more PFs.

In some aspects, one or more XaaS functions (e.g., XC, PF) can be deployed in one or more of: a radio access network (RAN), a core network (CN) and a user equipment (UE) side. For example, an XC can be deployed in the network control plane, and a PF can be deployed in the network user plane or the data plane. Some aspects of the disclosure may provide for deployment of PF into a network, e.g., into the RAN and UE side.

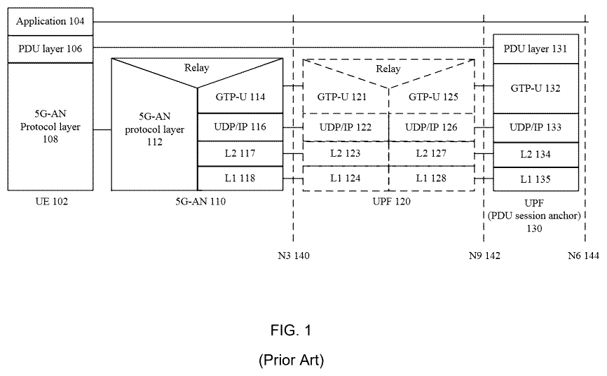

FIG. 1 illustrates a user plane protocol stack between a user equipment (UE) and a user plane function (UPF). As illustrated, the protocol stack at UE 102 may comprise an application layer 104, PDU layer 106, and a 5G-access network (AN) protocol layer 108. The UE 102 may interface a 5G-AN node 110 as illustrated. The protocol stack at a 5G-AN node 110 may comprise 5G-AN protocol layer 112, GTP-U layer 114, UDP/IP layer 116, L2 layer 117, and L1 layer 118.

The 5G-AN node 110 may connect with a UPF 120 via an N3 interface 140. The protocol stack of UPF 120 interfacing the 5G-AN node 110 may comprise a GTP-U layer 121, a UDP/IP layer 122, an L2 layer 123, and an L1 layer 124. The UPF 120 may connect with a UPF PDU session anchor 130 using an N9 interface 142. The protocol stack of UPF 120 interfacing the UPF PDU session anchor 130 may comprise a GTP-U layer 125, a UDP/IP layer 126, an L2 layer 127, and an LI layer 128, as illustrated. The UPF PDU session anchor 130 may connect with a data network via an N6 interface 144. The protocol stack at UPF PDU session anchor 130 may comprise a PDU layer 131, a GTP-U layer 132, a UDP/IP layer 133, an L2 layer 134, and an L1 layer 135.

Referring to FIG. 1 and considering an example of downlink data traffic (which may be similar to uplink data traffic which originates from application layer of UE side), data traffic flow and data mapping between different protocol layers, for traditional connectivity-orientated communication network, may be as follows.

Application data (e.g., service data flow (SDF)) may be encapsulated into Protocol Data Unit (PDU) layer data or packet (e.g., TCP or IP packets) and transmitted to one or more core network (CN) functions (e.g., a user plane function (UPF)).

The one or more CN functions (e.g., UPF) may classify the PDU layer data for quality of service (QOS) flow marking (e.g., based on packet detection rule) and further map the QoS flows to GTP-U tunnels. The one or more CN functions may map the PDU layer data to GTP-U layer data. If PDU session resource is setup under control of one or more of AMF, SMF and RAN, the mapping between GTP-U tunnels & PDU session/QoS flow on N3 interface may be aligned between UPF 130 and 120 & RAN (c.g., 5G-AN node 110).

The RAN may map QoS flows received via specific GTU-U tunnels to Access Network resources (e.g., DRBs). Then, UE 102 may map QoS flow to DRB based on its local configuration or the informed information (e.g., the mapping information between QoS flow and DRB) from RAN or CN. For example, UE 102 may map the downlink data of a specific DRB to a PDU session (QOS flow) to submit to PDU layer and application layer. In some circumstances, UE 102 may map uplink application data and PDU layer data to a PDU session/QoS flow, and then to a specific DRB to transmit to peer RAN.

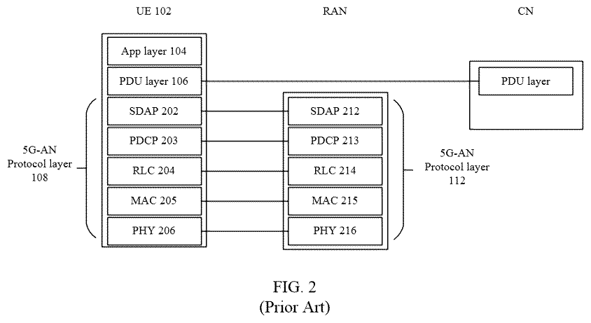

For RAN (e.g., 5G-AN node 110) to perform mapping between QoS flow and DRB, in reference to FIG. 2, a DRB may be configured with Service Data Adaptation Protocol (SDAP) sublayer, Packet Data Convergence Protocol (PDCP) sublayer, Radio Link Control (RLC) sublayer, Medium Access Control (MAC) sublayer and Physical Layer (PHY). One PDU session may be configured with one SDAP entity. One DRB may be configured with one PDCP entity. The data of a PDU session including one or more QoS flows may be mapped to one or more DRB(s) by the SDAP sublayer.

FIG. 2 illustrates a user plane protocol stack between a UE and a radio access network (RAN). As illustrated, the 5G-AN protocol layer 108, at UE 102, may comprise an

SDAP sublayer 202, a PDCP sublayer 203, an RLC sublayer 204, a MAC sublayer 205, and a PHY layer 206. The 5G-AN protocol layer 112, at RAN, may comprise an SDAP sublayer 212, a PDCP sublayer 213, an RLC sublayer 214, a MAC sublayer 215, and a PHY layer 216.

For downlink transmission, a UE SDAP entity may receive SDAP SDUs from upper layers and submits SDAP PDUs to its peer SDAP entity via lower layers. For uplink transmission, a UE SDAP entity of UE may deliver SDAP SDUs to upper layers and receives SDAP PDUs from its peer SDAP entity via lower layers.

As may be appreciated by a person skilled in the art, procedures or operations described in reference to FIG. 1 and FIG. 2 are designed with the objective of data forwarding. In these procedures, data is processed transparently in each layer without parsing and understanding the payload (except that the UE application layer may parse the data). For example, service data unit (SDU) may be processed (e.g., ciphering, segmentation, ordering) by each layer without parsing and understanding the SDU payload. Thereafter, the processed data (e.g., PDU) may be transmitted to next layer based on the data mapping scheme.

The data processing (e.g., ciphering, segmentation, ordering) and data mapping procedures may be understood as connectivity oriented. However, for 6G, parsing and processing of data within the network (e.g., by RAN) instead of within the application layer, may be desirable. Such functionality (e.g., parsing and processing of data) may be needed when the network (e.g., RAN) natively provides XaaS.

Further, parsing and processing of data by XaaS functions may be desirable e.g., in procedures related to AI training, AI inference, data privacy protection, etc. However, one or more sublayers and layers in the current 5G RAN, illustrated in FIG. 1 and FIG. 2, may lack the required functionality to support XaaS and to execute the one or more tasks in XaaS.

Moreover, in 5G, RAN may not be the source or destination of user plane (UP) data. In terms of data source, RAN may not generate UP data, rather, in 5G RAN, UP data is received from either CN (e.g., UPF) or UE. In terms of data destination, upon receiving UP data, RAN may not intercept, reserve, and use the received UP data, rather, RAN may forward, as soon as possible, the received UP data to either the CN (if uplink) or UE (if downlink).

Referring to FIG. 1 and FIG. 2, each sublayer or layer on UP, in current 5G RAN, may not be the source or destination of UP data. Upon receiving UP data, each sublayer or layer on UP, in current 5G RAN, may forward the received UP data to its lower or upper layer (and not intercept, reserve, and use the received UP data).

However, in 6G, a RAN may be a source or a destination of UP data. In some aspects, RAN itself can generate totally new data (e.g., RAN, as a sensor, may sense and generate sensing data, RAN may generate trained AI model by transforming the training data). In some aspects, RAN may be a destination of uplink data received from UE. For example, uplink data (e.g., intermediate AI parameters) received from UE may be aggregated, terminated, and used by RAN (e.g., for RAN to obtain a final AI model which may be used by RAN to optimize network) instead of being forwarded to CN.

As may be appreciated by a person skilled in the art, current RAN protocol stack may not support 6G new demands e.g., XaaS. Aspects of the disclosure may provide for improved RAN functionality, other than data forwarding. According to an aspect, RAN may support provision of XaaS e.g., RAN may parse and process data, RAN may serve as a source or destination of UP data.

For over the air link, related to the current 5G air interface, two types of Radio Bearers exist: Signaling Radio Bearer (SRB) which carries Radio Resource Control (RRC) signaling on control plane, and Data Radio Bearer (DRB) which carries data traffic on user plan. However, the SRB and DRB may not carry XaaS data, as these radio bearers may be limited to forwarding PDU layer data. According to an aspect, an improved bearer is provided which may support XaaS data (e.g., AI data, DAM data, private data, blockchain data, etc.).

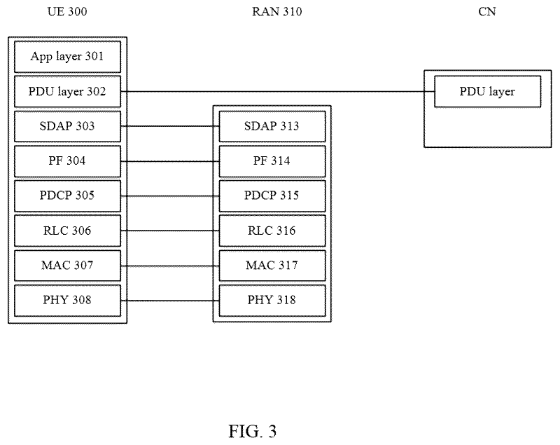

According to an aspect, a data PF for XaaS, on RAN side, may be provided. FIG. 3 illustrates an embodiment of an enhanced UP protocol stack between a UE and a RAN, according to an aspect of the present disclosure. According to an aspect, a PF in RAN may be deployed as a RAN radio Layer2 protocol sublayer, e.g., PF sublayer 314, between the SDAP sublayer 313 and PDCP sublayer 315 as illustrated.

In some aspects, the protocol stack at UE 300 may comprise an application layer 301, a PDU layer 302, an SDAP sublayer 303, a PF sublayer 304, a PDCP sublayer 305, an RLC sublayer 306, a MAC sublayer 307, and a PHY layer 308. In some aspects, the protocol stack at RAN 310 may comprise an SDAP sublayer 313, a PF sublayer 314, a PDCP sublayer 315, an RLC sublayer 316, a MAC sublayer 317, and a PHY layer 318.

In some aspects, based on the PF sublayers 304 and 314, one or more enhanced bearers that support 6G services may be provided.

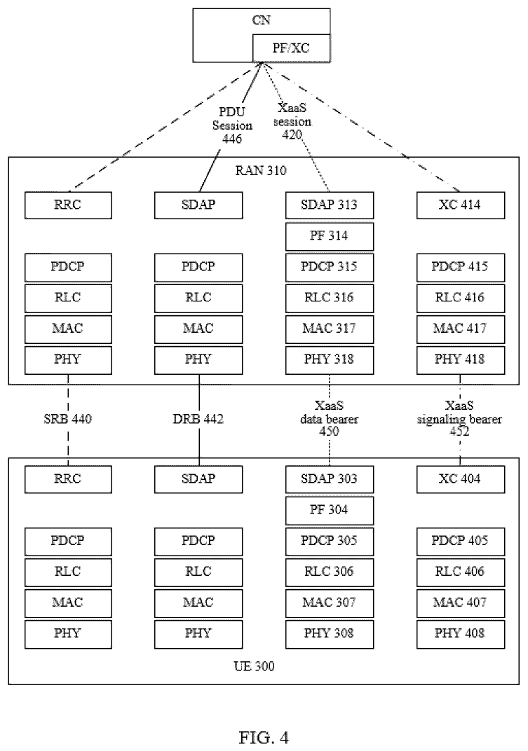

FIG. 4 illustrates an embodiment of XaaS bearers in 6G, according to an aspect of the present disclosure. In an aspect, protocol layers at RAN 310 and UE 300 may be enhanced to support XaaS data bearer 450 and XaaS signalling bearer 452 in 6G. For supporting XaaS data bearer 450, protocol stack at RAN 310 and UE 300 may each comprise PF sublayer 314 and 304 respectively as described herein. For supporting XaaS signalling bearer 452, protocol stack at RAN 310 and UE 300 may each comprise an XC sublayer 414 and 404 receptively.

Data forwarding in 5G may involve SRB 440 and DRB 442, between RAN 310 and UE 300 as illustrated.

Data forwarding service in 5G may further involve a PDU Connectivity Service, as may be defined and provided by, for example, a 5G network. A PDU connectivity service may refer to a service that provides exchange of PDUs between a UE and a Data Network.

Data forwarding service in 5G may further involve one or more PDU sessions, e.g., PDU session 446, as may be defined in 5G network. A PDU session may refer to an association between a UE and a Data Network that provides a PDU connectivity service.

According to an aspect, 6G may involve an XaaS. XaaS may be a service that provides data processing between a UE and a CN XaaS function, e.g., a PF deployed in CN, or a Data Network.

In some aspects, an XaaS may be a service that provides data processing between an XaaS customer and an XaaS network function, e.g., between a UE and a CN XaaS function, between a server of a third party and a CN XaaS function, between a UE and a DN, between DN and a CN PF, and between a server and a RAN node, etc.

In some aspects, XaaS in 6G may further involve an XaaS session 420. XaaS session may refer to an association between an XaaS customer and an XaaS network function that provides an XaaS. In some aspects, an XaaS session 420 may be an association between a UE 300 and a CN XaaS function (e.g., a PF deployed in CN, or a Data Network) that provides an XaaS. In some aspects, XaaS session 420 can be established between a UE and a CN PF unit, or between a UE and a DN.

In some aspects, 6G XaaS may be implemented on the top of 5G PDU connectivity service. In some aspects, establishing an XaaS session may comprise establishing relevant resources (e.g., connectivity resource, computing resource, and storage resource) used to complete an XaaS task. In some aspects, an XaaS session can be regarded as an improved PDU session aimed at data processing in addition to data forwarding.

In some aspects, through the XaaS session, data may be processed in different nodes flexibly, e.g., in CN PF unit, in PF sublayer 314 of RAN, in PF sublayer 304 of UE. The number of participating nodes (e.g., RANs, UEs, and CN functions) in an XaaS session may not be limited. Accordingly, an XaaS session may go through several RAN nodes, and these RAN nodes may cooperate to process the XaaS data in sequence or parallel.

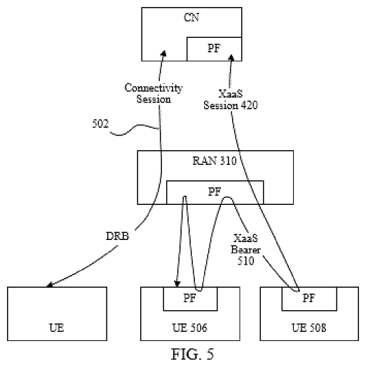

In some aspects, XaaS in 6G may further involve XaaS bearer (510 in FIG. 5 which may include XaaS data bearer 450 and XaaS signaling bearer 452). An XaaS bearer may refer to the service provided by the RAN radio Layer 2, including the PF sublayer and the XC sublayer, for both data transfer and data processing between UE 300 and RAN 310. In some aspects, XaaS bearers may refer to channels offered by RAN radio Layer 2, including PF and XC sublayers, to higher layers for both data transfer and data processing. Accordingly, PF and XC sublayers may provide the upper layers with the service of data forwarding and data processing between the UE and RAN by means of XaaS bearer. The service access points between a PF sublayer and upper layers (or an XC sublayer and upper layers) may be the XaaS bearers.

In some aspects, XaaS bearers may include XaaS data bearers (XDB) 450 for user plane data. In some aspect, each XDB may be configured with a PF sublayer 314 at RAN and 304 at UE, a PDCP sublayer 315 at RAN and 305 at UE, an RLC sublayer 316 at RAN and 306 at UE, a MAC sublayer 317 at RAN and 307 at UE, and PHY layer 318 at RAN and 308 at UE.

In some aspects, XaaS bearers may include XaaS signaling bearers (XSB) 452 for control plane data. In some aspects, each XSB 452 may be configured with a XC sublayer 414 at RAN and 404 at UE (rather than PF sublayer), a PDCP sublayer 415 at RAN) and 405 at UE, an RLC sublayer 416 at RAN and 406 at UE, a MAC sublayer 417 at RAN and 407 at UE, and PHY layer 418 at RAN and 408 at UE as illustrated. In some aspects, the XC sublayer 414 at RAN and 404 at UE, may sit on the top of PDCP sublayer 415 at RAN and 405 at UE, to transmit signaling message between RAN and UE, e.g., to configure and control PF sublayer.

In some aspects, XaaS in 6G may further involve XaaS QoS flow. According to an aspect, XaaS QoS Flow may be the finest granularity of QOS differentiation in XaaS Session 420. In some aspects, traffic mapped to the same XaaS QoS Flow may receive the same data forwarding treatment and data processing treatment.

Providing different XaaS QoS data processing treatment and data forwarding treatment may requires separate XaaS QoS Flow. An XaaS QoS Flow ID (XQFI) may be used to identify an XaaS QoS Flow. An XQFI may be a scalar ID that is used as a reference for specific XaaS QoS characteristics. Traffic (e.g., User Plane traffic) with the same XQFI within an XaaS Session may receive the same data processing treatment and data forwarding treatment. Data processing treatment may refer to computing accuracy, computing latency, privacy level, storage duration, data processing policy, data cleaning policy, data normalization policy, etc. Data forwarding treatment may include scheduling policy, queue management policy, link layer protocol configuration (e.g., MAC/RLC configuration), admission threshold, etc. In some aspects, the XQFI may be carried in an encapsulation header (e.g., a GTP-U packet header, a SDAP packet header, a segment routing over IPv6 (SRv6) packet header, a Quick UDP Internet Connections (QUIC) packet header) of the CN, the UE or RAN packets.

In some aspects, XaaS in 6G may further involve XaaS QoS parameters. XaaS QoS parameters may include both parameter on data forwarding treatment and parameter on data processing treatment. In some aspects, XaaS QoS parameters can be configured per node (e.g., per UE), per network function, per XaaS session, per XaaS QoS flow, or per XaaS Bearer.

In some aspects, data forwarding treatment parameters may include one or more of: data transfer resource scheduling policy, data queue management policy, data transfer priority level, link layer protocol configuration (e.g., MAC/RLC configuration), admission threshold, data loss rate, data transfer latency, data forwarding security protection method, security level, etc. Data forwarding treatment parameters may relates to data forwarding in data plane e.g., in RAN L2/L1 layers, and in CN UPF.

In some aspects, data processing treatment parameters may include one or more of: data processing scheduling policy, computing accuracy, computing latency, AI model type, privacy protection method, privacy level, data storage duration, data processing policy, data cleaning policy, data normalization policy, data quality level, data processing priority, etc. Data processing treatment parameters may relate to the data processing in a UE PF sublayer, RAN PF sublayer, or CN PF.

In some aspects, the data forwarding treatment parameters and data processing treatment parameters may be cross-adjusted and dynamic adapted, e.g., under the control of XC or other control plane functions. For example, data transfer latency and computing latency can be cross adjusted to guarantee a total latency threshold of an XaaS task, e.g., reducing the data transfer latency while increasing the computing latency for trade-off.

In some aspects, one or more data forwarding treatment parameters may correlate with one or more data processing treatment parameters. For example, guaranteeing a data forwarding treatment parameter (e.g., data loss rate) may be a prerequisite to guarantee a data processing treatment parameter (e.g., computing accuracy).

In some aspects, one XaaS session may be configured with one SDAP entity. Each XaaS Bearer may be configured with one PF entity. Each DRB may be associated with one PDCP entity. In some aspects, the SDAP sublayer may perform mapping between data of XaaS QoS flow(s) and XaaS bearer(s). One or more XaaS QoS flows may be mapped onto one Xaas bearer. One or more XaaS bearers can be further mapped onto one or more DRBs.

In some aspects, if the traffic granularity of XaaS QoS flow is the same as that of the XaaS bearer, the mapping between the XaaS QoS flow and XaaS bearer may not be needed and the SDAP entity may, thus, not be configured.

FIG. 5 illustrates an embodiment of 6G data treatment, according to an aspect of the present disclosure. For traditional connectivity-oriented service, e.g., service 502, a PDU session is established between UE and DN, where UL or DL data is transferred between UE and CN DN without bifurcation (e.g., without changing traffic direction). Thus, in traditional connectivity-oriented service, a RAN node may serve as a pipe to forward the received data (DL or UL) from the CN or UE to lower or upper layer without intercepting or reserving data. The UL or DL data traffic received by RAN is forwarded unidirectionally. For example, RAN cannot send the UL UP data received from UE back to UE directly, or the DL UP data received from CN DN back to CN DN directly.

According to an aspect, for 6G XaaS, UL or DL data traffic received by RAN 310 may be forwarded bidirectionally or multi-directionally, in part due to one or more of: the PF sublayer, XaaS bearer 510 and XaaS session 420. For example, RAN 310 can send UL UP data received from a UE 506 (which may be similar to UE 300) back to the UE 506 or another UE 508 (which may also be similar to UE 300) after data processing. RAN 310 can also send DL UP data received from CN (e.g., CN PF, or CN DN) back to CN after data processing. As another example, RAN 310 can send UL UP data received from a UE to another RAN via PF sublayer after data processing. RAN 310 may also send DL UP data received from a CN function (e.g., CN PF, or CN DN) to another CN function via PF sublayer after data processing.

According to an aspect, through the XaaS session, data may be processed among different nodes flexibly, e.g., in PF sublayer of RAN, in PF sublayer of UE, and in CN PF unit. The number of nodes (e.g., RANs, UEs, and CN functions) participating in a XaaS session may not be limited. For example, an XaaS session may go through one or more RAN nodes, and these RAN nodes may cooperate to process the XaaS data in sequence or parallel. In some aspects, the participation order and routine for different nodes can be flexible.

Moreover, different from deploying PF out of RAN, e.g., in MEC or cloud, deploying PF in RAN radio Layer 2 can enable the RAN to be aware of and adjust the performance of XaaS. For example, RAN may be aware of adjust performance of XaaS based on one or more of: joint consideration of XaaS requirement (e.g., data processing and forwarding requirements), XaaS resource state (e.g., data processing resource (e.g., computing load) and data forwarding wireless resource (e.g., wireless CSI state).

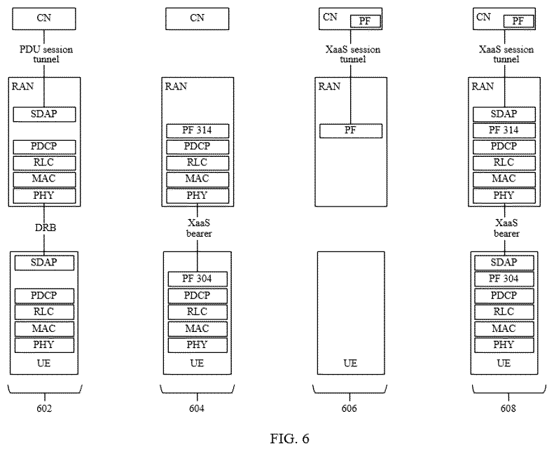

FIG. 6 illustrates an embodiment of a dynamic configuration for different cases, according to an aspect of the present disclosure. In some aspects, RAN may only be required to perform data-forwarding service, and not have XaaS capability or RAN need not be involved in the XaaS, e.g., case 602. In such cases, data need not be processed at RAN, and thus PF sublayer may not be configured in RAN, and RAN may operate according to 5G RAN capability. As illustrated, in case 602 a PDU session tunnel may be established between CN and RAN, and a DRB may be established between RAN and UE.

In some aspects, RAN may have XaaS capability and XaaS may only involve RAN and UE (no CN involved), e.g., case 604. In such cases, PF sublayer 314 may be configured at RAN, however, RAN SDAP sublayer and XaaS session tunnel between RAN and CN may not be configured. Further, PF sublayer 304 may be configured at UE as illustrated. Additionally, an XaaS bearer may be established between RAN and UE.

In some aspects, RAN may have XaaS capability, and XaaS may be processed in RAN and CN only, e.g., case 606. In such cases, PF sublayer may be configured at RAN. However, the SDAP sublayer, the radio L2 sublayers and the PHY layer may not be configured at the RAN.

In some aspects of case 606, the SDAP sublayer may be configured at the RAN (where the SDAP PDUs at the SDAP layer may be configured to contain data field and no packet header (e.g., no DL SDAP header or UL SDAP header)) while the radio L2 sublayers and the PHY layer may not be configured at RAN, at the same time. Further PF may be configured at the CN. Additionally, an XaaS session tunnel may be established between RAN and CN to support RAN XaaS capability.

In some aspects, a XaaS may be sequentially processed by the CN, the RAN, and the UE, e.g., case 608. In such cases, sublayers including the SDAP sublayer, the PF sublayer, the PDCP sublayer, the RLC sublayer, the MAC sublayer, and the PHY layer may be configured at the RAN and the UE. Further, a XaaS session tunnel between the CN and the RAN may be configured. As well, an XaaS bearer may be established between the RAN and the UE as illustrated.

According to an aspect, the data mapping among an upper layer (c.g., PDU layer, GTP-U layer), the SDAP sublayer, the PF sublayer, and the PDCP sublayer may be provided. According to another aspect, a functional view of a PF sublayer may be provided. According to another aspect, a structural view of the PF sublayer may be provided. According to another aspect, format, and parameters of PF sublayer Protocol data unit (PDU) may be provided. According to another aspect, the data mapping schemes for different cases (e.g., where a UE or a group of UEs and the RAN-PF are involved in a task of XaaS) may be provided. In some aspects, XaaS bearer can be configured per UE or per UE group.

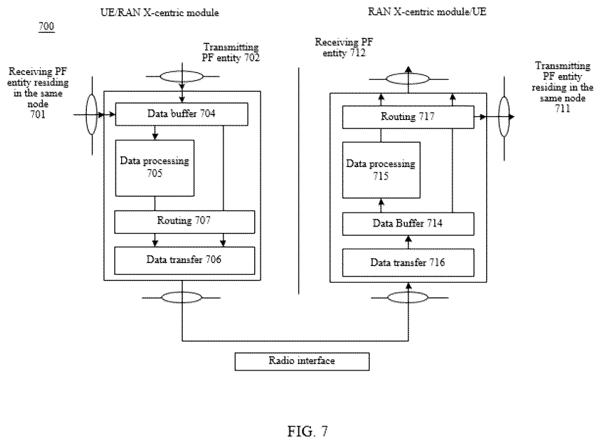

FIG. 7 illustrates an embodiment of a functional view of a PF sublayer, according to an aspect of the present disclosure. The PF sublayer 700 may comprise one or more PF entities as illustrated. In some aspects, one or more PF entities (e.g., a transmitting PF (Tx-PF) entity 702 or a receiving PF (Rx-PF) entity 712) may be deployed or configured in a node (e.g., in UE, CN side and RAN side).

In an aspect, if the Tx-PF entity 702 is deployed in UE, then Rx-PF entity 712 may be deployed in RAN. Similarly, if Tx-PF entity 702 is deployed in RAN, then the Rx-PF entity 712 may be deployed in UE.

FIG. 7 may be based on a radio interface protocol architecture. As may be appreciated by a person skilled in the art, FIG. 7 is only an illustration, according to an aspect, of PF sublayer, and thus not a limitation on how PF sublayer may be implemented. Other reasonable implementation of PF sublayer 700 may be known by a person skilled in the art and are part of the scope of one or more aspects of the disclosure.

In some aspects, if a transmitting PF entity is deployed in UE, then a receiving PF entity may be deployed in RAN. Similarly, if a transmitting PF entity is deployed in a RAN node, then a receiving PF entity may be deployed in the UE.

In an aspect, the PF entities 702 and 712 may be located in the PF sublayer for XaaS. In some aspects, several PF entities may be configured for a UE or a RAN node. In some aspects, in 6G, for each individual XaaS bearer over the air link, a PF entity may be configured.

In some aspects, a PF entity may receive (or deliver) PF SDUs from (or to) upper layers or another PF entity and may submit (or receive) PF PDUs to (or from) its peer PF entity via lower layers.

In some aspects, a transmitting PF entity 702 may receive PF SDUs from upper layers and submit or transmit PF PDUs to its peer PF entity via lower layers. In some aspects, a transmitting PF entity 702 may receive PF SDUs from another PF entity (e.g., from a Receiving PF entity residing in the same node) and submit or transmit PF PDUs to its peer PF entity via lower layers.

In some aspects, a receiving PF entity 712 may deliver PF SDUs to upper layers and receives PF PDUs from its peer PF entity via lower layers. In some aspects, a receiving PF entity 712 may deliver PF SDUs to another PF entity (e.g., to a transmitting PF entity residing in the same node) and receives PF PDUs from its peer PF entity via lower layers.

As may be appreciated by a person skilled in the art, in 5G data forwarding approach, each sublayer of RAN may only receive data from upper or lower layer and forward the received data to lower or upper layer. Thus, in 5G, RAN may serve as an intermediate pipe for forwarding data.

According to an aspect, in XaaS of 6G, RAN (c.g., PF sublayer) can be a data destination and data source. In some aspects, a PF entity may receive (or deliver) data from (or to) upper or lower layer. In some aspects, a PF entity may further receive (or deliver) data from (or to) another PF entity in the same PF sublayer and same node. In some aspects, a PF entity may enable XaaS data traffic to be originated, terminated or both at RAN in the PF sublayer. For example, 6G sensing data can be originated at RAN.

In some aspects, a PF entity may serve or operate as one or both of a transmitting PF (PF-Tx) entity 702 and receiving PF (PF-Rx) entity 712. Thus, one or more PF entities may be deployed on a same node, and each PF entity may serve as a PF-TX entity or a PF-RX entity.

According to an aspect, a PF sublayer (via one or more PF entities) may comprise a data buffer component 704 and 714 for supporting data buffer operations (e.g., user plane data). In some aspects, the PF sublayer may comprise a data processing component 705 and 715 for supporting data processing operations (e.g., user plane data). Data processing operations may include operations involving AI and data privacy protection, among others. In some aspects, the PF sublayer may comprise a data transfer component 706 and 716 for supporting data transfer operations (e.g., user plane data). Data transfer operations may include one or more of: PF header addition or removal; maintenance of PF Sequence Numbers (SNs), e.g., sequence numbering; and reordering and in-order delivery. In some aspects, the PF sublayer may comprise a routing component 707 and 717 for support routing operations.

Although components (e.g., data buffer, data processing, routing, and data transfer) are shown as separate from each other, in some aspects, one component may serve the function of two or more components.

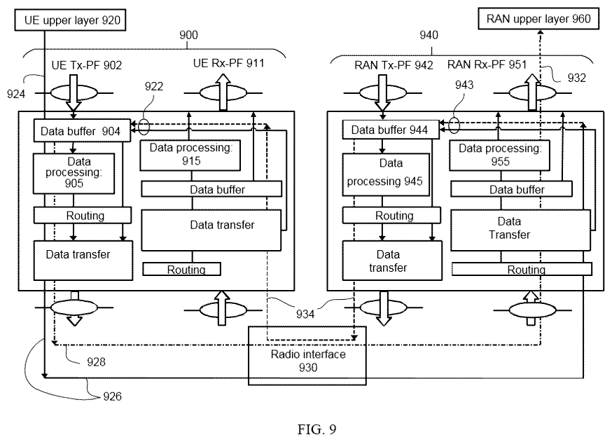

In some aspects, on the same node that a PF entity may reside, a corresponding PF entity may also reside. For example, in the same node that the Tx-PF entity 702 may reside, an Rx-PF entity 701 may also reside. Similarly, in the same node that the Rx-PF entity 712 may reside, a Tx-PF entity 711 may also reside. Thus, according to an aspect, the Tx-PF entity 702 may receive data from upper layer(s) (e.g., CN, SDAP sublayer when PF sublayer is deployed below the SDAP sublayer) and also from the same layer (e.g., Rx-PF entity 701) as further illustrated in FIG. 9.

According to an aspect, a PF entity may buffer data, via a data buffer component 704 and 714, to achieve “Big data” (as may be understood by a person skilled in the art). The obtained “Big data” may then be used for data processing 705 and 715. For example, a Tx-PF entity 702 may buffer the PF SDUs received from upper layer or another PF entity (e.g., from a Rx-PF entity residing in the same node 701). Similarly, a Rx-PF entity 733 may buffer PF PDUs received from its peer Transmitting PF entity via lower layers.

As an example, in NET4Data service, DAM service and NET4AI service, a Rx-PF entity 712 may buffer data from one or more Rx-PF entities to achieve “Big data” data processing purposes. Data processing may include AI training, data privacy protection (e.g., privacy protection with K-anonymity method)). Similarly, a Tx-PF entity may buffer data received from upper layers or another PF entity (e.g., from a Rx-PF entity residing in the same node 701), to achieve “Big data” for subsequent data processing.

According to an aspect, data processing may involve a PF entity parsing and processing data with one or more methods of AI training, AI inference, data analytics, privacy protection, data pre-processing (e.g., data cleaning, data normalization, useless data filtering, and data feature engineering).

According to an aspect, at the transmitting side, when a PF entity (e.g., a Tx-PF entity 702) receives one or more PF SDUs from upper layers or another PF entity (e.g., from a Rx-PF entity residing in the same node 701), the PF entity may construct a corresponding PF PDU and submits it to lower layers.

According to an aspect, constructing a PF PDU, may include parsing and processing raw data encapsulated in the payload of one or more PF SDUs with one or more methods (e.g., AI training, AI inference, data privacy protection). The constructing of PF PDUs is different from the traditional 5G connectivity-oriented network where the PDU of each RAN sublayer is constructed without parsing the payload of the SDU.

In some aspects, after receiving the PF SDU, one or more parameters associated with the data processing treatment of the PF SDU may be triggered by the PF entity. The one or more parameters may be related to QoS requirement on the XaaS bearer and be optionally pre-configured at PF entity by XC. The one or more parameters may include: a time count threshold within which the PF PDU may be constructed, an accuracy level according to which the PF SDU may be processed, and a privacy level according to which the PF PDU may be guaranteed.

According to an aspect, at the receiving side, when a PF entity (e.g., Rx-PF entity 712) receives a PF PDU from lower layers, the PF entity may retrieve the corresponding PF SDU. In some aspects, the PF entity may deliver the PF SDU to upper layers, or to another PF entity (e.g., to a transmitting PF entity 711 residing in the same node (e.g., RAN) of the Receiving PF entity).

In some aspects, after retrieving the corresponding PF SDU from lower layers, the PF entity may parse and process the retrieved one or more PF SDUs. The PF entity may deliver the processed PF SDU to upper layers, or to another PF entity (e.g., to a transmitting PF entity residing in the same node 711 (e.g., RAN) of the Receiving PF entity).

In some aspects, after the PF SDUs are retrieved, the raw data encapsulated in one or more of the retrieved PF SDUs may be parsed and processed with specific methods (e.g., AI training, AI inference, data privacy protection). As may be appreciated by a person skilled in the art, the parsing and processing of PF SDUs may be different from the traditional 5G connectivity-oriented network where the retrieved SDU is forwarded out directly without parsing and processing.

As described herein, the PF SDU or the processed PF SDU may be forwarded by the Rx-PF entity 712 to a Tx-PF entity residing in the same node 711 (e.g., RAN) of the Receiving PF entity. In some aspects, the transmitting PF entity 711 may forward the PF SDU or the processed PF SDU to a receiving PF entity residing in peer node (e.g., UE(s) or another RAN). These operations performed by the Rx-PF entity 712 and the transmitting PF entity 711 may be different from traditional 5G connectivity-oriented network where the retrieved SDU are forwarded to upper layers. The PF entity (Rx-PF entity and Tx-PF entity) operations described herein may be applicable to the scenarios where the XaaS task is executed between UE and RAN, and the XaaS task is terminated at RAN and the CN is not involved.

In some aspects, after receiving the PF PDU, one or more parameters associated with the data processing treatment of the PF PDU may be triggered by the PF entity. The one or more parameters may be related to XaaS bearer QoS and optionally pre-configured to PF entity by XC. The one or more parameters may include: a Time Count threshold within which the PF PDU should be processed, an accuracy level according to which the retrieved PF SDU may be processed, and a privacy level according to which the processed PF SDU may be guaranteed.

As an example, in NET4AI service, a PF entity may parse the payload of the received SDU and use it to train an AI model. For example, a Tx-PF entity in RAN side and a Rx-PF entity in UE side may cooperate with each other to train an AI model.

As another example, in DAM service, a PF entity may process data (which may include or indicate identifying information) to protect data privacy. For example, a PF entity may process the payload of SDU with one or more operations e.g., obfuscation-, cryptography-, hardware-or AI-based privacy protection method, to remove or hide the identifying information or anonymize the data.

In some aspects, data privacy protection may be executed in either Tx-PF entity or Rx-PF entity or both. Moreover, PF entity may further process non-directly usable, useless and redundant data, e.g., may perform data cleaning, data normalization, useless data filtering, and data feature engineering.

As another example, in NET4Data or DAM service, a PF entity may receive sensing data from a sensor and buffer the received sensing data into a local storage, e.g., for further use of the sensing data.

According to an aspect, a PF sublayer, via one or more PF entities, may support data transfer operations performed by the data transfer component 706 and 716. In some aspects, functions relating to transfer of data may include sequence numbering and addition or removal of PF header.

In some aspects, at reception of a PF SDU from upper layers or anther PF entity (e.g., from a Rx-PF entity residing in the same node 701), a Tx-PF entity 702 may store the received PF SDU in the reception buffer. In some aspects, the Tx-PF entity may process the received PF SDU. In some aspects, the Tx-PF entity may further construct a corresponding PF PDU. In some aspects, the Tx-PF entity may further perform sequence numbering to set the PF SN. In some aspects, the Tx-PF entity may further sequentially submit the PF PDU to lower layers. The PF PDU may be used to convey one or more of followings: PF header, and payload encapsulating the user plane data (i.e., the received PF SDU or the processed PF SDU). In some aspects, the PF SN may be contained in the PF header.

According to some aspects, at reception of a PF PDU from lower layers, a Rx-PF entity 712 may remove PF header and retrieve the PF SDU. In some aspects, the Rx-PF entity 712 may further store the resulting PF SDU in the reception buffer. The Rx-PF entity 712 may further process the resulting PF SDU and sequentially deliver the resulting PF SDU or the processed PF SDU to upper layers or another PF entity (e.g., to a Tx-PF entity residing in the same node 711).

In some aspects, the Tx-PF entity 702 may add packet routing information to the header of the PF PDU. In some aspects, at the Rx-PF entity 712 may retain the routing information to the header of the PF SDU to let routing module to decide the routing actions, e.g., to decide to submit packet to upper layer or to another Tx-PF entity.

According to an aspect, a PF sublayer, via one or more PF entities, may further support routing 710. In some aspects, a Tx-PF entity 702 may add routing information to PF sublayer packet (e.g., to the header of the PF PDU) to help a Rx-PF entity of peer node to decide the routing actions, i.e., to decide whether the processed data (e.g., original retrieved SDU or processed SDU) should be submitted to upper layer or to another PF entity.

According to an aspect, the routing information can be configured to a Tx-PF entity by control plane (e.g., by XC controller).

In some aspects, the routing information can be generated by the Tx-PF entity 702 itself based on the processed results (e.g., generated by the data processing component 705 of

Tx-PF entity). For example, if the processed result does not reach the required data processing treatment parameters (e.g., accuracy level or privacy level of an AI model, or the AI model does not converge (e.g., in federated learning or generative adversarial network training)), the Tx-PF entity 702 may need a peer node's cooperation to continue data processing for further one or more rounds. Then, the Tx-PF entity 702 may generate routing information (e.g., the data processing component 705 of Tx-PF entity 702 may generates the routing information) and add the routing information into PF sublayer packet (e.g., to the header of the PF PDU) to notify or indicate to the peer node that continuous data processing is needed in the peer node and the processed results need to be submitted to PF sublayer and transmitted back to the transmitting PF entity rather than being submitted to upper layers.

In some aspects, the Rx-PF entity 712 may decide the routing actions based on routing information. The Rx-PF entity 712 may decide whether the processed data (e.g., original retrieved SDU or processed SDU) should be submitted to upper layer or to another PF entity (e.g., a transmitting PF entity residing in the same node 711).

According to an aspect, the routing information can be configured at the Rx-PF entity 712 by control plane (e.g., by XC controller). In some aspects, the routing information can be included in the PF sublayer packet (e.g., in the header of PF PDU) via a peer Tx-PF entity adding the routing information therein.

In some aspects, the routing information may be generated by the Rx-PF entity 712 itself based on the processed results (e.g., generated by the data processing component 715 of Rx-PF entity). In some aspects, if the processed result does not reach the required data processing treatment parameters (e.g., accuracy level or privacy level of an AI model, or the AI model does not converge yet (e.g., in federated learning or generative adversarial network training)), the Rx-PF entity 712 may need a peer node's cooperation to continue data processing for several round. Then, the Rx-PF entity 712 may generate routing information (via the data processing component 715) and inform the routing component 717 to submit the processed results to PF sublayer rather than to submit to upper layers.

In some aspects, the routing information may be used by Rx-PF entity 712 to decide the address of the next-hop node.

While in some aspects, the PF sublayer (and corresponding implementation of the one or more PF entities and PF sublayer) may be described as being deployed between the SDAP sublayer and the PDCP sublayer, the PF sublayer is not limited to such deployment and may be deployed at any reasonable location. For example, the PF sublayer may be deployed between the PDCP and RLC sublayers, between RLC and MAC sublayers, between MAC and PHY sublayers, on top of SDAP sublayer, on top of PDU layer, on top of GPRS Tunneling Protocol for the user plane (GTP-U) layer, on top of User Datagram Protocol (UDP) layer, on top of Internet Protocol (IP) layer, on top of Quick UDP Internet Connections (QUIC) layer or deployed within any of PDU layer, SDAP sublayer, PDCP sublayer, RLC sublayer, MAC sublayer, PHY layer, GTP-U layer, DUP layer, IP layer and QUIC layer.

The participation sequence of the different functions (performed by the different components, e.g., data buffer component 704 and 714, data processing component 705 and 715, routing component 707 and 717, and data transfer component 706 and 716) of the PF entities (whether Tx-PF entity 702 or Rx-PF entity 712) is not limited to the illustrated diagrams. Any reasonable sequence of one or more operations performed by the one or more components in the PF entities may fall within the scope of an aspect of the disclosure.

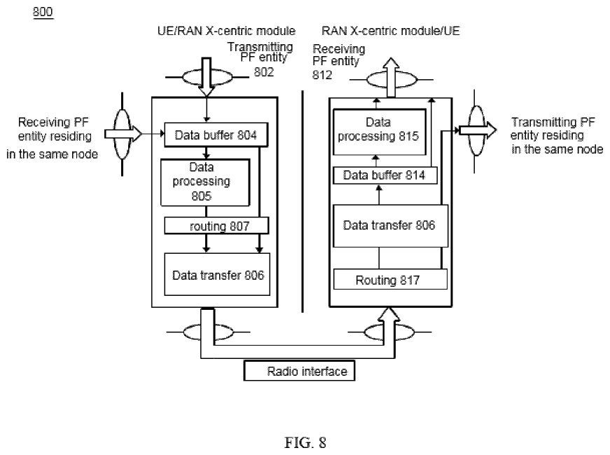

According to an aspect, the participation sequence of the one or more operations performed by one or more components in the PF entities may be adjusted flexibly. For example, the sequence of operations involved in determining whether the retrieved SDU should be processed (i.e., the retrieved SDU processed by the data processing component 715) in Rx-PF entity 712 before being forwarded to the transmitting PF entity residing in the same node 711, etc., may be adjusted flexibly. FIG. 8 illustrates an embodiment of another sequence of different components of a Rx-PF entity 812, in a PF sublayer, in accordance with the present disclosure.

FIG. 8 illustrates another functional view of a PF sublayer, according to an aspect. Similar to PF sublayer 700, PF sublayer 800 may comprise one or more PF entities (Tx-PF entity 802 and Rx-PF entity 812) as illustrated. The Tx-PF entity 802 may have a similar participation sequence of the one or more PF entity's components to that of the Tx-PF entity 702 of PF sublayer 700. The Tx-PF entity 802 may comprise one or more of: a data buffer component 804, a data processing component 805, a routing component 807, and a data transfer component 806). As illustrated, the Rx-PF entity 812 may have a different participation sequence of the one or more components compared to the participation sequence of the one or more components in the Rx-PF entity 712 (of PF sublayer 700). For example, Rx-PF entity 712 may determine data routing, via routing component 717, after having data buffering operations performed, by the data buffer component 714, whereas Rx-PF entity 812 may determine data routing, via routing component 817, without having initially the data buffering operations performed (by the data buffer component 814). Another example of the different participation sequence at Rx-PF entity 812 and at Rx-PF entity 712 may relate to the data transfer operations. At Rx-PF entity 812, the data transfer operations (performed by data transfer 806) may occur after routing decisions are performed by routing component 817, whereas at Rx-PF entity 712, the data transfer operations, performed by data transfer component 717, are performed before the routing decisions are performed (e.g., by the routing component 717).

FIG. 9 illustrates an embodiment of data path in a PF sublayer, according to an aspect of the present disclosure. PF sublayer 900 at UE may comprise a Tx-PF entity 902 and a Rx-PF entity 911, residing in the same node (e.g., UE). PF sublayer 940 at RAN may comprise a Tx-PF entity 942 and a Rx-PF entity 951, residing in the same node (e.g., a RAN node).

According to an aspect, the UE Rx-PF entity 911 may transmit data 922 (which may be processed data) to the UE Tx-PF entity 902 (e.g., to the data buffer component 904 of the UE Tx-PF entity 902). Similarly, the RAN Rx-PF entity 951 may transmit data 943 (which may be processed data) to the RAN Tx-PF entity 942 (e.g., to the data buffer component 944 of the RAN Tx-PF entity 942).

In some aspects, the UE Tx-PF entity 902 may receive data 924 from UE upper layer 920 and process the data 924 to obtain processed data 926. The UE Tx-PF entity 902 may further transmit the processed data 926 to RAN Rx-PF entity 951 of RAN PF sublayer 940 via radio interface 930.

In some aspects, the UE Tx-PF 902 may transmit data 928 (which may be processed data), buffered at the data buffer component 904, to the RAN PF sublayer 940 (RAN Rx-PF 951) via the radio interface 930. In some aspects, the RAN Rx-PF entity 951 may transmit data 932 (which may be processed data) to one or both of RAN upper layer 960 and RAN Tx-PF entity 942. In some aspects, the RAN Tx-PF entity 942 may transmit data 934 (e.g., data stored at data buffer component 944) to UE PF sublayer 900 (e.g., to UE Rx-PF 911) via the radio interface 930.

In some aspects, the UE Tx-PF entity 902 may receive data 924 from UE upper layer 920 and perform processing on data via e.g., data processing component 905, to obtain processed data 926. The processed data 926 may then be transmitted to RAN Rx-PF entity 951 of RAN PF sublayer 940 via radio interface 930. In some aspects, the RAN Rx-PF entity 951 of RAN PF sublayer 940 may perform further processing, e.g., via data processing component 955, on the processed data 926 to obtain further processed data 943. The RAN Rx-PF entity 951 of RAN PF sublayer 940 may further transmits the further processed data 943 to the RAN Tx-PF entity 942 of RAN PF sublayer 940. In some aspects, the RAN Tx-PF entity 942 of RAN PF sublayer 940 may further process, via data processing component 945, the processed data 943 to obtain further processed data 934. The RAN Tx-PF entity 942 of RAN PF sublayer 940 may further transmit the processed data 934 to UE PF sublayer 900 (c.g., to UE Rx-PF 911) via the radio interface 930. In some aspects, the UE Rx-PF entity 911 of UE PF sublayer 900 may further process the received processed data 934, via data processing component 915, to obtain further processed data 922. In some aspects, the UE Rx-PF entity 911 of UE PF sublayer 900 may further transmit the processed data 922 to the UE Tx-PF entity 902 (e.g., the Data buffer 904) of UE PF sublayer 900. The UE Tx-PF entity 902 of UE PF sublayer 900 may further process the received processed data 922, via data processing component 905, to obtain processed data 928. In some aspects, the UE Tx-PF entity 902 of UE PF sublayer 900 may further transmit the processed data 928 to the RAN Rx-PF entity 951 of RAN PF sublayer 940 via the radio interface 930. In some aspects, the RAN Rx-PF entity 951 of RAN PF sublayer 940 may further process the processed data 928, via data processing component 955, to obtain processed data 932. The RAN Rx-PF entity 951 of RAN PF sublayer 940 may further transmit the processed data 932 to the RAN upper layer 960.

In some aspects, a PF entity at the UE e.g., the UE Tx-PF entity 902 may receive raw data 924 from a protocol layer of the UE and perform processing on the raw data 924 via e.g., data processing component 905, to obtain processed data 926. The protocol layer of the UE may be one of: a network sensing layer, a PF sublayer, a PHY layer, a RLC sublayer, a MAC sublayer, a PDCP sublayer, a SDAP sublayer, a PDU layer, and a reconfigurable intelligent surface (RIS) layer. In some aspect, the raw data 924 may be sensing data, RIS data, data of the internet of things, positioning data, or other types of data collected by the protocol layer of the UE e.g., collected from one or more RAN nodes or CNFs. The processed data 926 may then be transmitted to the RAN Rx-PF entity 951 of the RAN PF sublayer 940 via radio interface 930. In some aspects, the RAN Rx-PF entity 951 of RAN PF sublayer 940 may perform further processing, e.g., via data processing component 955, on the processed data 926 to obtain further processed data 943. The RAN Rx-PF entity 951 of RAN PF sublayer 940 may further transmits the further processed data 943 to the RAN Tx-PF entity 942 of RAN PF sublayer 940. In some aspects, the RAN Tx-PF entity 942 of RAN PF sublayer 940 may further process, via data processing component 945, the processed data 943 to obtain further processed data 934. The RAN Tx-PF entity 942 of RAN PF sublayer 940 may further transmit the processed data 934 to UE PF sublayer 900 (e.g., to UE Rx-PF 911) via the radio interface 930. In some aspects, the UE Rx-PF entity 911 of UE PF sublayer 900 may further process the received processed data 934, via data processing component 915, to obtain further processed data 922. In some aspects, the UE Rx-PF entity 911 of UE PF sublayer 900 may further transmit the processed data 922 to the UE Tx-PF entity 902 (e.g., the Data buffer 904) of UE PF sublayer 900. The UE Tx-PF entity 902 of UE PF sublayer 900 may further process the received processed data 922, via data processing component 905, to obtain processed data 928. In some aspects, the UE Tx-PF entity 902 of UE PF sublayer 900 may further transmit the processed data 928 to the RAN Rx-PF entity 951 of RAN PF sublayer 940 via the radio interface 930. In some aspects, the RAN Rx-PF entity 951 of RAN PF sublayer 940 may further process the processed data 928, via data processing component 955, to obtain processed data 932. The RAN Rx-PF entity 951 of RAN PF sublayer 940 may further transmit the processed data 932 to the RAN upper layer 960.

In some aspects, the procedure may start from a PF entity at the RAN e.g., the RAN Tx-PF entity 942 of the RAN PF sublayer 940 may receive raw data 943 from a protocol layer of the RAN. The protocol layer of the RAN may be one of: a network sensing layer, a PF sublayer, a PHY layer, a RLC sublayer, a MAC sublayer, a PDCP sublayer, a SDAP sublayer, a PDU layer, a reconfigurable intelligent surface (RIS) layer, a GTP-U layer, a QUIC layer, a SRv6 layer, a UDP layer, and a hypertext Transfer Protocol (HTTP) layer. In some aspect, the raw data 943 may be sensing data, RIS data, data of the internet of things, positional data, or other types of data collected by the protocol layer of the RAN e.g., collected from one or more UEs or CNFs. In some aspects, the RAN Tx-PF entity 942 of RAN PF sublayer 940 may further process, via data processing component 945, the raw data 943 to obtain further processed data 934. The RAN Tx-PF entity 942 of RAN PF sublayer 940 may further transmit the processed data 934 to UE PF sublayer 900 (e.g., to UE Rx-PF 911) via the radio interface 930. In some aspects, the UE Rx-PF entity 911 of UE PF sublayer 900 may further process the received processed data 934, via data processing component 915, to obtain further processed data 922. In some aspects, the UE Rx-PF entity 911 of UE PF sublayer 900 may further transmit the processed data 922 to the UE Tx-PF entity 902 (c.g., the Data buffer 904) of UE PF sublayer 900. The UE Tx-PF entity 902 of UE PF sublayer 900 may further process the received processed data 922, via data processing component 905, to obtain processed data 928. In some aspects, the UE Tx-PF entity 902 of UE PF sublayer 900 may further transmit the processed data 928 to the RAN Rx-PF entity 951 of RAN PF sublayer 940 via the radio interface 930. In some aspects, the RAN Rx-PF entity 951 of RAN PF sublayer 940 may further process the processed data 928, via data processing component 955, to obtain processed data 932. The RAN Rx-PF entity 951 of RAN PF sublayer 940 may further transmit the processed data 932 to the RAN upper layer 960.

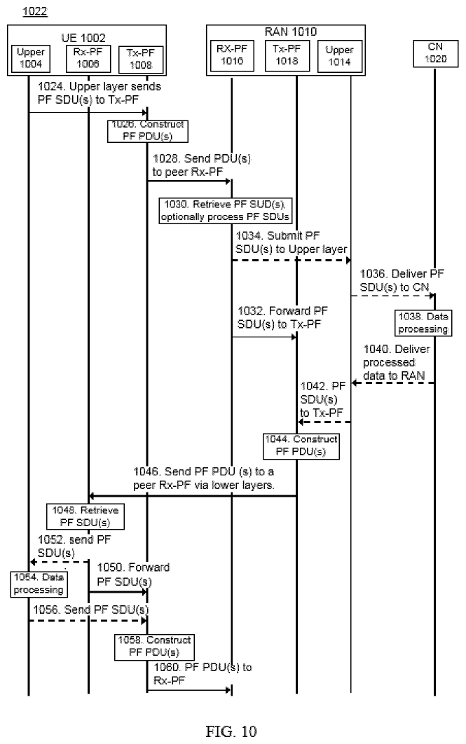

FIG. 10 illustrates a sequence diagram of a process 1022 of an XaaS task of PF sublayer according to an embodiment of the present disclosure. Referring to FIG. 10, on the UE side, upper layer(s) 1004 and a UE PF sublayer (Rx-PF entity 1006 and Tx-PF entity 1008) may be deployed. Similarly, on the RAN side, upper layers 1014 and a RAN PF sublayer (Tx-PF entity 1018 and Rx-PF entity 1016) may be deployed. In some aspects, the UE PF sublayer RAN PF sublayer of FIG. 10 may be similar to UE PF sublayer 900 and RAN PF sublayer 940 of FIG. 9.

According to an aspect, an XaaS task may involve a receiving side (e.g., RAN node 1010) sending processed data, received from a transmitting side (e.g., UE 1002), back to the transmitting side, instead of forwarding to an upper layer (e.g., RAN SDAP, PDU layer, or CN). For example, the RX-PF entity 1016 residing in RAN node 1010 may receive one or more PF PDUs from the Tx-PF entity 1008 residing in the UE 1002. The Rx-PF entity 1016 may retrieve and process some or all the one or more PF SDUs to obtain processed PF SDUs. In an aspect, the processed PF SDUs in the RAN node 1010 may need to be sent back to the UE 1002 instead of upper layers (e.g., RAN SDAP, PDU layer, or CN), according to process 1022.

According to an aspect, the process 1022 may involve forwarding the processed data (e.g., the processed PF SDUs) of the Rx-PF entity 1016 to the Tx-PF entity 1018 residing in the same node (c.g., RAN node 1010). The Tx-PF entity 1018 may deliver the processed data encapsulated in one or more PF PDUs to the Rx-PF entity 1006 residing in a peer node (c.g., UE 1002) via lower layers. In an aspect, the process 1022 may be executed based on associated XC's configuration indicating that a XaaS, associated with process 1022, may be terminated at RAN-PF, e.g., indicating that only UE and RAN, rather than CN, may be involved in the XaaS task.

According to an aspect, process 1022 may involve a PF sublayer at the UE 1002, the RAN node 1010 and the CN 1020. The process 1022 may include UE upper layer 1004 (e.g., SDAP sublayer, PDU layer) delivering or sending 1024 one or more PF SDUs of XaaS to a Tx-PF entity 1008 residing in the UE 1002 (c.g., UE Tx-PF 1008).

In an aspect, the one or more PF SDUs may be used for one or more of: AI training, AI inference, data analytics, data privacy protection, data cleaning, data normalization, useless data filtering, data feature engineering, etc.

The process 1022 may further include UE Tx-PF entity 1008 constructing 1026 one or more PF PDUs based on the received one or more PF SDUs. In some aspects, constructing the one or more PF PDUs may include UE Tx-PF entity 1008 performing one or more of: data buffering, data processing, PF header addition, and data sequence numbering.

In some aspects, data processing may be performed with one or more methods comprising: AI training, AI inference, data analytics, data privacy protection, data cleaning, data normalization, useless data filtering, or data feature engineering, etc.

In some aspects, the process 1022 may further include UE Tx-PF entity 1008 sending 1028 the constructed one or more PF PDUs to a peer RAN Rx-PF entity 1016 via lower layers, e.g., of XaaS bearer 510.

In some aspects, process 1022 may further include RAN Rx-PF entity 1016 retrieving 1030 the one or more PF SDUs from the received one or more PF PDUs. In some aspects, RAN Rx-PF entity 1016 may further processes the retrieved one or more PF SUDs. RAN Rx-PF entity 1016 may perform one or more of: PF header removal, reordering based on SN, data buffering, and data processing.

In some aspects, the data processing may be performed based on one or more methods: AI training, AI inference, data analytics, data privacy protection, data cleaning, data normalization, useless data filtering, data feature engineering, etc.

In some aspects, if CN 1020 needs to be involved in XaaS, process 1022 may include, RAN Rx-PF entity 1016 forwarding 1032 the retrieved or the processed one or more PF SDUs to Tx-PF entity 1018 residing in the RAN (RAN Tx-PF entity 1018).

In some aspects, if CN 1020 needs to be involved in XaaS task, then process 1022 may include RAN Rx-PF entity 1016 submitting or sending 1034 the retrieved or the processed one or more PF SDUs to RAN upper layer(s) 1014 (e.g., SDAP sublayer, GTP-U layer, UDP layer, IP layer, QUIC layer, or PDU layer).

In some aspects, process 1022 may further include RAN upper layer(s) 1014 delivering or sending 1036 upper layer data encapsulating the one or more PF SDUs to CN, e.g., UPF or PF deployed in CN, e.g., via XaaS QoS flow or XaaS session tunnel between RAN and CN.

In some aspects, process 1022 may further include CN 1020 using the PF SDUs to perform data processing 1038. Data processing may be performed based on one or more methods: AI training, AI inference, data analytics, data privacy protection, data cleaning, data normalization, useless data filtering, or data feature engineering, etc.

In some aspects, process 1022 may further include CN 1020 delivering or sending 1040 the processed data to RAN upper layer 1014 (e.g., SDAP sublayers, GTP-U layer, UDP layer, IP layer, QUIC layer, or PDU layer), e.g., via XaaS QoS flow or XaaS session tunnel between RAN and CN. RAN upper layer 1014 may then deliver or send 1042 the one or more PF SDUs encapsulating CN's processed data to RAN Tx-PF entity 1018.

In some aspects, process 1022 may further include RAN Tx-PF entity constructing 1044 corresponding one or more PF PDUs of the PF SDUs. Constructing one or more PF PDU(s) may include, RAN Tx-PF entity 1018 performing one or more of: data buffering, data processing, PF header addition, and data sequence numbering.

In some aspects, data processing may be performed based on one or more methods including: AI training, Al inference, data analytics, data privacy protection, data cleaning, data normalization, useless data filtering, or data feature engineering, etc.

In some aspects, process 1022 may further include RAN Tx-PF entity 1018 delivering or sending 1046 the constructed one or more PF PDUs to a peer UE Rx-PF entity 1006 via lower layers e.g., of XaaS bearer.

In some aspects, process 1022 may further include UE Rx-PF entity 1006 retrieving 048 the one or more PF SDUs from the received one or more PF PDUs. In some aspects, UE Rx-PF entity 1006 may further process the one or more PF SUDs.

In some aspects, if UE upper layer 1004 (e.g., Application layer) need not be involved in the XaaS, i.e., when data is terminated at UE PF sublayer, then process 1022 may further include, UE Rx-PF 1006 forwarding or sending 1050 the retrieved or the processed PF SDUs to UE Tx-PF entity 1008.

In some aspects, if the UE upper layer (e.g., Application layer) need to be involved in the XaaS, i.e., when data is not terminated at PF sublayer, then process 1022 may further include UE Rx-PF entity 1006 submitting or sending 1052 the retrieved or the processed one or more PF SDUs to UE upper layer(s) 1004 (e.g., SDAP sublayer, PDU layer, or Application layer).

In some aspects, process 1022 may further include UE upper layer(s) 1004 (e.g., Application layer) using the one or more PF SDUs to perform data processing 1054. Data processing may be performed based on one or more methods including AI training, AI inference, data analytics, data privacy protection, data cleaning, data normalization, useless data filtering, data feature engineering, etc.

In some aspects, process 1022 may further include UE upper layer(s) sending 1056 one or more PF SDU encapsulating UE's processed data to UE Tx-PF entity 1008.

In some aspects, process 1022 may further include UE Tx-PF entity 1008 constructing 1058 one or more PF PDUs corresponding to one or more PF SDUs. To construct the one or more PF PDUs, RAN Tx-PF entity 1008 may perform one or more of: data buffering, data processing, PF header addition, and data sequence numbering.

In some aspects, data processing may be performed based one or more methods including AI training, AI inference, data analytics, data privacy protection, data cleaning, data normalization, useless data filtering, data feature engineering, etc.

In some aspects, process 1022 may further include UE Tx-PF entity 1008 sending the constructed one or more PF PDU to peer RAN Tx-PF entity 1016 via lower layers, e.g., of XaaS bearer.

In some aspects, process 1022 may further include one or more operations, repeated, until XaaS tasks are completed. The one or more operations may include operations in reference to 1030, 1032, 1034, 1036, 1038, 1040, 1042, 1044, 1046, 1048, 1050, 1052, 1054, 1056, 1058, and 1060.

Workflow or process 1022 may be used to perform an XaaS task. According to an aspect, workflow 1022 may be used to perform an XaaS task associated with NET4AI service.

According to an aspect, one or more of UEs (e.g., UE 1002) may be active as a participant of federated learning, and a RAN (e.g., RAN node 1010) as an aggregator of federated learning. In an aspect, referring to FIG. 10, UE upper layer (e.g., SDAP sublayer, PDU layer) may deliver 1024 one or more PF SDUs encapsulating local private data to UE Tx-PF entity 1008. UE Tx-PF entity 1008 may use the private data to train a local model, and then encapsulate the trained local model parameters into the payload of one or more PF PDUs, when constructing 1026 the one or more PF PDUs. UE Tx-PF entity 1008 may then deliver or send 1028 the one or more PF PDU to RAN Rx-PF entity 1016 via lower layers, e.g., of XaaS bearer.

In some aspects, RAN Rx-PF entity 1016 may retrieve 1030 UE's local model parameters from the received one or more PF PDUs. RAN Rx-PF entity 1016 may further aggregate one or more local parameters of multiple UEs and obtains global model parameters.

In some aspects, the RAN Rx-PF entity 1016 may further forward 1032 the one or more PF SDUs including global model parameters to RAN Tx-PF entity 1018.

In some aspects, RAN Tx-PF entity 1016 may submit or send 1034 one or more PF SDUs including UE's local parameters to RAN upper layer 1014.

1036. RAN upper layer may then deliver 1036 the one or more PF SDUs to CN 1020, e.g., UPF or PF deployed in CN. The CN 1020 may aggregate 1038 local parameters of multiple UEs and obtains the global model parameters. The CN 1020 may further delivery 1040 the global model parameters to RAN upper layer 1014 (e.g., SDAP sublayers, GTP-U layer), e.g., via XaaS QoS flow or XaaS session tunnel. The RAN upper layer 1014 may then send 1042 the one or more PF SDU encapsulating global model parameters to RAN Tx-PF 1018.

In some aspects, RAN Tx-PF entity 1018 may construct 1044 one or more PF PDUs corresponding to the one or more PF SDUs including the global model parameters. RAN Tx-PF entity 1018 may further add PF PDU header(s) and SN.

In some aspects, RAN Tx-PF entity 1018 may deliver or send 1046 the constructed one or more PF PDUs including the global model parameters to a peer UE Rx-PF entity 1006 via lower layers, e.g., of XaaS bearer.

The UE Rx-PF entity 1006 may retrieve 1048 the global model parameters from the received one or more PF PDUs. In some aspects, UE Rx-PF entity 1006 may further train the local model with the received latest global model parameters and local private data. The local private data may be buffered at Rx-PF entity 1006. In some aspects, the local private data may be part of the private data received from upper layers 1004 previously (e.g., received 1024 from upper layer 1004) or at some point after receiving 1024.

In some aspects, UE Rx-PF entity 1006 may forward 1050 the one or more PF SDUs including the latest trained local model parameters to Tx-PF entity 1008 residing in the UE.

In some aspects, UE Rx-PF entity 1006 may submit or send 1052 the retrieved global model parameters to UE upper layer 1004. In an aspect, the UE upper layer 1004 (e.g., application layer) may train 1054 the local model with the received latest global model parameters and local private data. The UE upper layer 1004 may further send 1056 the one or more PF SDUs including the latest trained local model parameters to UE Tx-PF entity 1008.

In some aspects, the UE Tx-PF entity 1008 may construct 1058 one or more PF PDUs corresponding to the one or more PF SDUs. The UE Tx-PF entity 1008 may further add PF PDU header and SN. The UE Tx-PF entity 1008 may further send 1060 the constructed one or more PF PDUs including the latest local model parameters to a peer RAN Rx-PF entity 1016 via lower layers, e.g., of XaaS bearer.

In some aspects, one or more operations may be performed until the until the federated learning model training task is completed. The one or more operations may include operations in reference to 1030, 1032, 1034, 1036, 1038, 1040, 1042, 1044, 1046, 1048, 1050, 1052, 1054, 1056, 1058, and 1060.

According to an aspect, workflow 1022 may be used to perform an XaaS task associated with a DAM service. For example, in a DAM service, a UE (e.g., UE 1002) may be active as a data source and report data to RAN (e.g., RAN node 1010) to be collected. The DAM service may include one or more of: protection of data privacy (e.g., location information); and cleaning, filtering, or normalizing of the non-directly usable, useless and redundant data.

In an aspect, the UE and RAN may cooperate to protect privacy of the reported data (identifying information of UE) based on one or more methods (e.g., generative adversarial network (GAN)).

In an aspect, performing the XaaS task associated with a DAM service may include UE upper layer 1004 (e.g., SDAP sublayer, PDU layer) feeding or sending 1024 one or more PF SDUs encapsulating private data into UE Tx-PF entity 1008.

The UE Tx-PF entity 1008 may use the PF SDU to train an adversarial network. In an aspect, UE Tx-PF entity 1008 may construct 1026 one or more PF PDUs and encapsulate the output of adversarial model into the payload of the one or more PF PDUs.

The UE Tx-PF entity 1008 may deliver or send 1028 the one or more PF PDUs to RAN Rx-PF entity 1016 via lower layers, e.g., of XaaS bearer. The RAN Rx-PF entity 1016 may retrieve 1030 the output of adversarial model from the received one or more PF PDUs. The RAN Rx-PF entity 1016 may then uses the retrieved output of adversarial model to train a generative model.

In some aspects, RAN Rx-PF entity 1016 may forward 1032 the one or more PF SDUs including the output of the generative model to RAN Tx-PF entity 1018.

In some aspects, the RAN Rx-PF entity 1016 may submit 1034 the one or more PF SUDs including the output of adversarial model to RAN upper layer 1014. The RAN upper layer 1014 may deliver 1036 the one or more PF SDUs to CN 1020, e.g., UPF or PF deployed in CN. In some aspects, the CN 1020 may use 1038 the output of adversarial model to train a generative model. The CN 1020 may further deliver or send 1040 the output of the generative model to RAN upper layer 1014 (e.g., SDAP sublayers, GTP-U layer). In an aspect, RAN upper layer 1014 may sends one or more PF SDUs encapsulating the output of generative model to RAN Tx-PF entity 1018.

The RAN Tx-PF entity 1018 may construct 1044 one or more PF PDUs corresponding to the one or more PF SDUs including the output of generative model. The RAN Tx-PF entity 1018 may further add PF PDU header and SN. The RAN Tx-PF entity 1018 may further deliver 1046 the constructed one or more PF PDUs including the output of generative model to peer UE Rx-PF entity 1006 via lower layers, e.g., of XaaS bearer.

In an aspect, UE Rx-PF entity 1006 may retrieve 1048 the output of generative model from the received one or more PF PDUs. The UE Rx-PF entity 1006 may further train a local adversarial model with the received latest output of generative model and local private data. The local private data may be buffered at Rx-PF entity 1006. In some aspects, the local private data may be part of the private data received from upper layers 1004 previously (e.g., received 1024 from upper layer 1004) or at some point after receiving 1024.

In some aspects, UE Rx-PF 1006 may forward 1050 one or more PF SDUs including the latest output of adversarial model to UE Tx-PF entity 1008. In some aspects, UE Rx-PF entity 1006 may submit or send 1052 the output of generative model to UE upper layer 1004).

In some aspects, UE upper layer 1004 (e.g., application layer) may train 1054 the adversarial model with the received latest output of generative model and local private data. In some aspects, UE upper layer 1004 may further send 1056 one or more PF SDUs including the latest output of adversarial model to UE Tx-PF entity 1008.

The UE Tx-PF entity 1008 may construct 1058 one or more PF PDUs corresponding to the one or more PF SDUs. UE Tx-PF entity 1008 may further add PF PDU header and SN. The UE Tx-PF entity 1008 may further send 1060 the constructed one or more PF PDU including the latest output of adversarial model to a peer RAN Rx-PF entity 1016 via lower layers, e.g., of XaaS bearer.

In some aspects, one or more operations may be performed until the GAN training task is completed. The one or more operations may include operations in reference to 1030, 1032, 1034, 1036, 1038, 1040, 1042, 1044, 1046, 1048, 1050, 1052, 1054, 1056, 1058, and 1060.

In some aspects, after the training is complete, the trained generative model at RAN Rx-PF entity 1016 can output generative data which may have the same properties of original UE private data. Thereafter, in some aspects, RAN Rx-PF entity 1016 may forward to RAN upper layer 1014 one or more PF SDUs including the latest output (i.e., the generated data) of trained adversarial model, or the parameters of the trained generative model. In some aspects, The RAN upper layer 1014 may deliver the generated data or the generative model to CN 1020, e.g., UPF or PF deployed in CN.

In some aspects, CN 1020 may be a data consumer which retains the generated data or the generative model for further use e.g., to perform data analytics. CN 1020, as a data consumer, may further exposes the generated data or the generative model to other data consumers, e.g., 3^{rd} party, for further use. In this way, the generated data, or the generative model, instead of the original UE private data, may be exposed to data consumer, thereby protecting UE's privacy.

According to an aspect, workflow 1022 may used to perform an XaaS associated with a DAM service. In an aspect, UE upper layer 1004 (e.g., SDAP sublayer, PDU layer) may deliver 1024 one or more PF SDUs encapsulating data (to be reported to RAN) to UE Tx-PF entity 1008.

The UE Tx-PF entity 1008 may clean, normalize, or filter the non-directly usable, useless and redundant data included in the one or more PF SDUs, e.g., based on preconfigured data processing rules. In some aspects, the UE Tx-PF entity 1008 may further provide a level of privacy protection to (e.g., by removing or replacing identifying information from) information included in the one or more PF SDU. The UE Tx-PF entity 1008 may further construct 1026 one or more PF PDUs and encapsulates the processed data into the payload of the one or more PF PDUs.

In some aspects, the UE Tx-PF entity 1008 may deliver or send 1028 the one or more PF PDU to RAN Rx-PF entity 1016 via lower layers, e.g., of XaaS bearer. The RAN Rx-PF entity 1016 may retrieve 1030 the one or more PF SDUs. The RAN Rx-PF entity 1016 may further clean, normalize or filter the non-directly usable, useless and redundant data included in the one or more retrieved PF SDUs. The RAN Rx-PF entity 1016 may further perform feature engineering, e.g., based on preconfigured data processing rules. The RAN Rx-PF entity 1016 may further provide a level of privacy protection to (e.g., by removing or replacing identifying information from) information included in the one or more PF SDU. In provide a level of privacy protection, the RAN Rx-PF entity 1016 may use one or more methods of privacy protection. For example, the RAN Rx-PF entity may buffer the one or more PF SDUs from K UEs and protects the data privacy with K-anonymity method.

In some aspects, the RAN Rx-PF entity may forward 1034 the one or more PF SDUs including the processed data to RAN upper layer 1014. The RAN upper layer 1014 may deliver 1036 the processed data to CN 1020, e.g., UPF or PF deployed in CN, e.g., via XaaS QoS flow or XaaS session tunnel. The CN 1020 may be a data consumer which reserves the processed data e.g., to perform data analytics. In some aspects, the CN 1020 may further expose the data to other data consumers, e.g., 3^{rd} party, for further use.

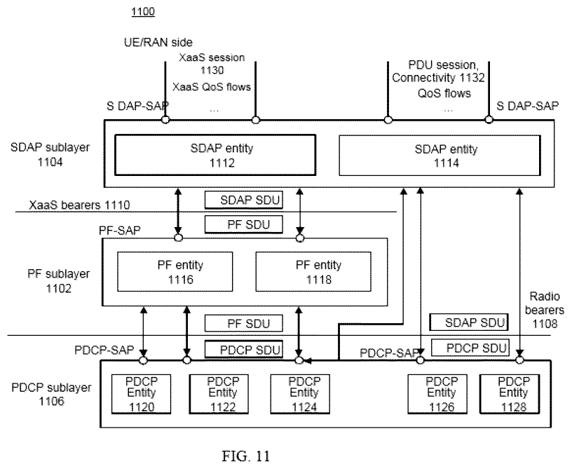

FIG. 11 illustrates an example of a structural view of a PF sublayer, according to an aspect of the present disclosure. The structural view 1100 is one possible structure for the PF sublayer and is not limited to such implementation, as may be appreciated by a person skilled in the art.

The PF sublayer 1102 may be deployed between SDAP sublayer 1104 and PDCP sublayer 1106. The PDCP sublayer 1106 may provide the radio bearers 1108 to the PF sublayer 1102. The PF sublayer 1102 may provide XaaS bearers 1110 to the SDAP sublayer 1104.

The SDAP sublayer 1104 may deploy one or more SDAP entity 1112 and 1114. The PF sublayer 1102 may deploy one or more of PF entities 1116 and 118. The PDCP sublayer 1106 may deploy one or more PDCP entities 1120, 1122, 1124, 1126 and 1128.

According to an aspect, an XaaS session 1130 may include different XaaS QoS flows. Each XaaS session 1130 may be configured with one SDAP entity (e.g., SDAP entity 1112). An SDAP entity may map the data included in the XaaS QoS flow to one or more PF entities. For example, one SDAP entity 1112 may map the data included in the XaaS QoS flow to two PF entities 1116 and 1118. A PF entity may further map the data to one or more PDCP entities. For example, PF entity 1116 may map the data to two different PDCP entities 1120 and 1122, and PF entity 1118 may map data to one PDCP entity 11124.

According to an aspect, an SDAP entity 1112 may support an XaaS session 1130. In some aspects an SDAP entity 1114 may support a 5G PDU session connectivity 1132.

In an aspect, the 5G PDU session connectivity 1132 may not be configured with a PF entity. For example, the SDAP entity 1114 (which is used for the 5G PDU session connectivity 1132) may connect directly with the PDCP sublayer 1106 (one or more PDCP entity). In an aspect, the SDAP entity 1114 may map 5G PDU session connectivity data to three PDCP entities 1124, 1126, and 1128.

In some aspects, a PDCP entity 1124 may carry data from both XaaS session 1130 and 5G PDU session connectivity 1132. Thus, PDCP entity 1124 may be multiplexed by Xaas session 1130 and 5G PDU session 1132.

According to an aspect, from a structural point of view, the PF sublayer 1102 may be an anchor of XaaS bearer(s) 1110. The function of the one or more PF entities 1116 and 1118 in the PF sublayer 1102 can be configured by RRC or dedicated XaaS signaling message, e.g., via XSB by XC sublayer.

In an aspect, FIG. 11 depict an architecture for downlink and uplink associated with XaaS and 5G PDU session connectivity service.

According to an aspect, for XaaS, the PDCP sublayer 1106 may offer or provide radio bearer(s) to the PF sublayer 1102. In some aspects, the PF sublayer 1102 may offer XaaS Bearers 1110 to the SDAP sublayer 1104. The SDAP sublayer may offer XaaS QoS flows of XaaS session to CN.

In some aspects, the SDAP sublayer 1104 may not be configured (or configured with the absence of DL SDAP header or UL SDAP header) if the traffic granularity of XaaS QoS flow or XaaS session is the same as that of the XaaS bearer. That is, there is a one-to-one mapping between an XaaS QoS flow or an XaaS session and a XaaS bearer. According to an aspect, the XaaS QoS flow or the XaaS session can be mapped to XaaS bearer one-to-one. For example, the XaaS session or XaaS QoS flow may be established between a UE and a CN PF instead of between the UE and a DN. The CN PF within the network itself can generate the XaaS QoS flow data traffic based on the granularity of XaaS bearer. So, in some aspects, the data traffic granularity can be aligned between the CN PF and the RAN, and the XaaS session or XaaS QoS flow can be mapped to XaaS bearer one to one without the SDAP sublayer.

In some aspects, the SDAP sublayer 1104 may not be configured (or may be configured with the absence of DL SDAP header or UL SDAP header) if the XaaS only involves UE and RAN. For example, only the UE and RAN may be involved on UP in an Xaas task, and the CN need not be involved in the XaaS task. The XaaS data may only be processed between UE and RAN, originated, or terminated at RAN-PF. Then the XaaS data need not be received from or forwarded to CN or UE upper layers (e.g., application layer), and the data mapping between the CN and RAN may thus not be needed. Only the over-the-air link may need to be established. Therefore, the SDAP sublayer 1104 may need not be configured. In this case, there may be only the XaaS bearer and no XaaS QoS flow between UE and RAN.

In some aspects, the SDAP sublayer 1104 may not be configured (or may be configured with the absence of DL SDAP header or UL SDAP header) if XaaS is processed in RAN and CN only. For example, the PF sublayer on RAN and CN tunnels between RAN and CN may be configured, while RAN SDAP sublayer and other radio L2 sublayers and PHY layer may not be configured.

In some aspects, for connectivity service, the PDCP sublayer 1106 may offer radio bearers 1108 to the SDAP sublayer 1104. In some aspects, for connectivity service, the PDCP sublayer 1106 may offer radio bearers to the PF sublayer 1102, the PF sublayer 1102 may offer XaaS Bearers 1110 to the SDAP sublayer 1104, but the PF sublayer 1102 may works in transparent mode (TM), i.e., the PF PDUs at the PF layer are configured to contain only data field and no packet header. Data goes through PF layer transparently without being processed. In some aspects, for connectivity service, the SDAP sublayer 1104 may offer connectivity QoS flows of PDU session to CN.

In some aspects, a radio bearer (e.g., DRB) can convey XaaS data only, connectivity service data only, or both XaaS data and connectivity data. That is, only one or more PF entities of PF sublayer for XaaS, only one or more SDAP entities of SDAP sublayer for Connectivity service, or aforementioned both can map the data to a same PDCP entity in the PDCP sublayer.

In some aspects, as may be appreciated by a person skilled in the art, for both Xaas and PDU connectivity service, the RLC sublayer may offer RLC channels to the PDCP sublayer. In some aspects, for both XaaS and PDU connectivity service, the MAC sublayer may offer logical channels to the RLC sublayer. In some aspects, for both XaaS and PDU connectivity service, the physical layer may offer transport channels to the MAC sublayer. In some aspects, for both XaaS and PDU connectivity service, the resource (e.g., a MAC entity, physical resource block) in RLC sublayer, MAC sublayer, and physical layer can be multiplexed by XaaS data and Connectivity service data.

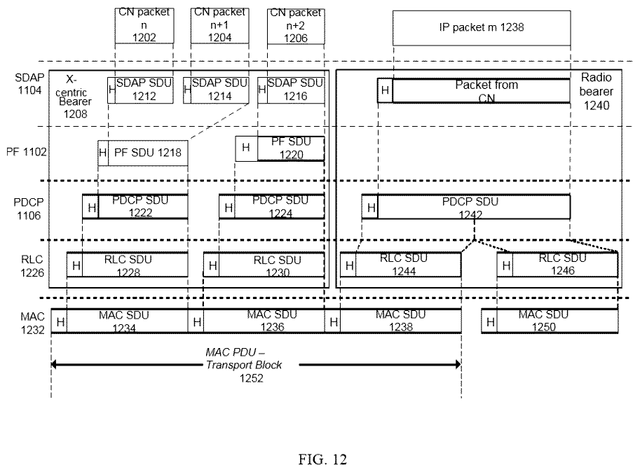

FIG. 12 illustrates an embodiment of a data flow, according to an aspect of the present disclosure. In an aspect, a CN may send one or more packets (e.g., CN packet n 1202, CN packet n+1 1204 and CN packet n+2 1206) associated with an XaaS.

The SDAP layer (via one or more SDAP entities) may receive and process the CN packets into SDAP SDUs. For example, SDAP layer process CN packet n 1202 into SDAP SDU 1212, CN packet n+1 1204 into SDAP SDU 1214, and CN packet n30 2 1216 into SDAP SDU 1216. Then SDAP layer adds a SDAP packet header to each SDAP SDU and encapsulates one SDAP SDU and one SDAP packet header into one SDAP PDU. In some aspects, the SDAP PDU may only contain the SDAP SDU without SDAP packet header.

The SDAP layer 1104 may transmit the SDAP PDUs to the PF sublayer for further processing. The PF sublayer 1102 (via one or more PF entities) may process the SDAP SDUs into PF SDUs. In an aspect, the PF sublayer may process packets SDAP SDU 1212 (corresponding to CN packet n 1202) and SDAP SDU 1214 (corresponding to CN packet n+1 1204) into PF SDU 1218. The PF sublayer 1102 may further process SDPA SDU 1216 (corresponding with CN packet n+2 1206) into PF SDU 1220. The PF sublayer 1102 may transmit the PF SDUs to PDCP sublayer 1106 for further processing. The PDCP sublayer 1106 (via one or more PDCP entities) may process the PF SDUs into PDCP SDUs. The PDCP sublayer may process the PF SDU 1218 into PDCP SDU 1222 and PF SDU 1220 into PDCP SDU 1224.

The PDCP sublayer 1106 may transmit the PDCP SDUs to the RLC sublayer 1226, which further processes the PDCP SDUs 1222 and 1224 into RLC SDU 1228 and 1230 respectively. In some aspect, one PDCP SDU may be further decoupled into multiple RLC SDUs (though no illustrated).

The RLC sublayer 1226 may transmit the RLC SDUs 1228 and 1230 to the MAC sublayer 1232, which processes the RLC SDUs 1228 and 1230 into MAC SDUs 1234 and 1236 respectively.

Referring to FIG. 12, a DN (e.g., a third party) may send one or more packets, e.g., IP packet m 1238, via a radio bearer 1240. The IP packet m 1238 may be processed and encapsulated in the PDCP sublayer 1106 into PDCP SDU 1242. The PDCP SDU 1242 may further be processed (e.g., encapsulated or decoupled) by RLC sublayer 1226 into RLC SDUs 1244 and 1246. The RLC sublayer 1226 may transmit the RLC SDUs 1244 and 1246 to the MAC layer 1232. The MAC sublayer 1232 may process the RLC SDUs 1244 and 1246 into MAC SDUs 1248 and 1250 receptively.

Referring to FIG. 12, the box ‘H’ may depict the header(s) or sub-header(s) of each sublayer's packet.

According to an aspect, the MAC sublayer 1232 may generate a MAC PDU 1252 based on one or more MAC SDUs received via X-centric bearer 1208 and radio bearer 1240. In an aspect, MAC sublayer 1232 may generate MAC PDU 1252 based on MAC SDUs received via X-centric bearer 1208 (e.g., MAC SDUs 1234 and 1236) and MAC SDU 1238 received via radio bearer 1240.

Accordingly, a transport block 1252 may be generated by MAC 1232 by concatenating three RLC PDUs: two RLC PDUs 1228 and 1230 from XaaS bearer 1208, and one RLC PDU1244 from radio bear 1240. The transport block 1252 may be transmitted via physical resource block.

As may be appreciated by a person skilled in the art, a PDU of an upper layer (e.g., RLC PDU) may be an SDU of the next lower layer (e.g., MAC SDU). The lower layer (e.g., MAC 1232) may add a packet header (‘H’ in the figure) to the SDU to obtain a lower layer PDU (e.g., a MAC SDU+a MAC packet header (H)=a MAC PDU). For example, in traditional connectivity service (5G), an SDAP SDU+an SDAP H=an SDAP PDU; an SDAP PDU=a PDCP SDU; a PDCP SDU+a PDCD H=a PDCP PDU. In some aspects, a PDCP PDU may be decoupled into one or more RLC SDUs. Further, an RLC SDU+an RLC H=an RCL PDU; an RLC PDU=a MAC SDU; a MAC SDU+a MAC H=a MAC PDU. In traditional connectivity service, the lower layer may not parse and understand the meaning (evaluate the information) in a PDU of the upper layer.

According to an aspect, a PF layer may be provided in XaaS (6G). In some aspects, one or more SDAP PDUs may be processed to obtain one PF SDU. For example, one or more SDAP PDU may be a training dataset which may be fed into the PF layer. The PF layer may parse and understand the meaning of the training dataset (e.g., evaluate the training dataset via performing one or more operations with the training data set, including processing the training data set). In an aspect, the PF layer may use the training dataset (i.e., SDAP PDUs, or the SDAP

SUDs contained in the SDAP PDUs) to obtain a trained model result, which may be in a form of a PF SDU. The PF layer may add a header to the PF SDU to obtain a PF PDU (e.g., a PF SDU+a PF H=a PF PDU). In some aspects, a PF PDU may be a PDCP SDU, or may be decoupled into multiple PDCP SDUs. Then, the PDCP layer may add a PDCP header to each PDCP SDU to obtain a PDCP PDU (e.g., a PDCP SDU+a PDCP H=a PDCP PDU).

In some aspects, one or more PF PDUs may be processed to obtain one new PF SDU, and then to construct a second PDUs. For example, one or more PF PDUs may be a training dataset which may be fed into the PF layer by a PF layer of a peer node via e.g., lower layers. The PF layer may parse and understand the meaning of the training dataset (e.g., evaluate the training dataset via performing one or more operations with the training data set, including processing the training data set). In an aspect, the PF layer may use the training dataset (i.e., PF PDUs, or PF SDUs contained in the PF PDUs) to obtain a trained model result, which may be in a form of a new PF SDU. The PF layer may add a header to the new PF SDU to obtain a second PF PDU (c.g., a PF SDU+a PF H=a PF PDU). In some aspects, a PF PDU may be a PDCP SDU, or may be decoupled into multiple PDCP SDUs. Then, the PDCP layer may add a PDCP header to each PDCP SDU to obtain a PDCP PDU (c.g., a PDCP SDU+a PDCP H=a PDCP PDU.

According to an aspect, the RLC PDU 1244 from radio bear 1240 may be a segment of an IP packet (m) 1238, e.g., the IP packet may be from a DN. The two RLC PDUs 1228 and 1230 from XaaS bearer 1208, each corresponds to one PDCP PDU, respectively, PDCP SDU 1222 and 1224.

One of the two PDCP PDUs, e.g., PDCP SDU 1222, from XaaS bearer 1208 may correspond to the data processing result of PF sublayer 1102 based on two CN packets (n 1202 and n+1 1204) e.g., the two CN packets may be from a CN PF. The other PDCP SDU 1224 may correspond to the data processing result of PF sublayer 1102 based on one CN packet (n+2) 1206, the CN packet may be from a CN PF. In some aspects, the CN packet (n+2) 1206 may be transferred to PDCP sublayer 1106 transparently by PF sublayer 1102 without data processing or PF header addition, i.e., the PF may be in transparent mode.

According to an aspect, PDU format and PDU parameter(s) of PF sublayer may be provided. In an aspect, PF PDU may have two types: data PDU and control PDU.

According to an aspect, a data PDU may be used to convey one or more of followings: PF header; user plane or data plane data. A control PDU may be used to convey control information, e.g., with only PF header but no user or data plane data encapsulated.

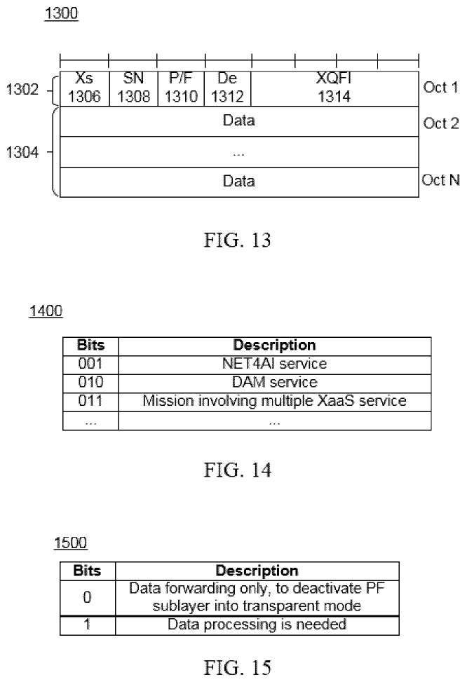

FIG. 13. Illustrates an embodiment of a format of PF PDU according to an aspect of the present disclosure. The PF PDU format 1300 may indicate one or more: control information (according to a packet header 1302) and payload 1304. A packet header 1302 may include one or more fields to indicate one or more of: Xs 1306, sequence number (SN) 1308, Processing or forwarding (P/F) directly 1310, Destination (De) 1312 and XaaS QoS Flow Identifier (XQFI) 1314. The payload may indicate the data. The data may be raw data or processed data.

According to an aspect, a PF PDU may be a bit string that is aligned in length (e.g., byte aligned with multiple of 8 bits). Referring to FIG. 13, bit strings may be represented by tables, the first and most significant bit of the bit string may be the left most bit of the first line of the table. Generally, the bit string may be read from left to right and then in the reading order of the lines.

In an aspect, a PF PDU may include one or more fields for indicating data. The length of data may be variable. In some aspects, the one or more fields indicating data may further includes the PF SDU.

According to an aspect, referring to UL data on UE side (or DL data on RAN side) as an example, a PF SDU may be refer to the original data received by a PF entity from upper layer (i.e., original PF SDU), e.g., from SDAP sublayer. In some aspects, a PF SDU may refer to the result of processing performed by a PF entity using the original PF SDU.

In some aspects, for XaaS, the original PF SDUs may be processed by PF sublayer according to one or more methods (e.g., AI training, data privacy protection), and the processed results, instead of the original PF SDUs, may be included into the PF PDU. The PF SDU may be included into PF PDU from the first bit onward. In some aspects, original PF original PF SDU may be included in PF PDU, e.g., when the PF sublayer of XaaS bearer works in transparent mode to provide connectivity service.

According to an aspect, referring to DL data on UE side (or UL data on RAN side) as an example, a PF SDU may refer to the original data retrieved by a PF entity from the received PF PDU from lower layer (i.e., the original retrieved PF SDU), e.g., from PDCP sublayer. In some aspects, a PF SDU may refer to the result of processing performed by a PF entity using the original retrieved PF SDU.

In some aspects, for XaaS, the original retrieved PF SDUs may be processed by PF sublayer with one or more method (e.g., AI training, data privacy protection), and the processed results, instead of the original retrieved PF SDUs, may be forwarded to upper layers or another PF entity. In some aspects, original retrieved PF SDU may be forwarded to upper layer, e.g., when the PF sublayer of XaaS bearer works in transparent mode to provide connectivity service.

In some aspects, the Xs field 1306 may have a length of x bits. The Xs field 1306 may indicate a type of XaaS that the PF data may belong to. In some aspects, the Xs field 1306 may indicate the type of XaaS in the case that the type of XaaS is not configured or specified for an XaaS bearer when the XaaS bearer (e.g., the PF entity) is established (e.g., when established under the control of control plane), e.g., the XaaS bearer is established as a common or default XaaS bearer for all types of services. The type of XaaS which the PF PDU may belong to may be indicated to a peer node for correct data processing, e.g., a UE may indicate a peer RAN node to provide DAM service of privacy protection on PF sublayer.

In some aspects, the data process type (e.g., data collection, data sanitization, data pre-processing or others) can be included in the Xs field 1306. In some aspects, the Xs field 1306 may be defined in finer granularity to further indicate the data process type. For example, the granularity may be at the level of “Process Type” to indicate data collection, data sanitization or other process types of the corresponding XaaS.

According to an aspect, the data process type can be configured to PF sublayer by control plane (e.g., by XaaS controller (XC) sublayer). When the PF entity is established in the XaaS bearer setup procedure, the PF entity may be configured by XC to indicate what process type may be chosen to process the data.

FIG. 14 illustrates an embodiment of a table indicating description of an Xs field, according to an aspect of the present disclosure. In some aspects, the Xs field 1306 may have a size of 3 bits (though other sizes may be applicable) for indicating one or more XaaS. For example, the Xs field may be set to ‘001’ to indicate that the packet belongs to a NET4AI service. The Xs field may be set to ‘010’ which may indicate that the packet belongs to a DAM service. The Xs field may be set to ‘011’ may indicate the that the as packet belongs to a Mission involving multiple XaaS.

According to an aspect, the SN field 1308 have a length of y bits. The SN field 1308 may indicate a sequence number of the PF PDU for data ordering or reordering. In some aspect, the data size (an Al training dataset, AI trained model parameters) for XaaS may be large and thus the sequence of data traffic (e.g., AI inference result) may be important. In large data size SN may be needed to have correct data ordering. In some aspects, the SN may also include a Task ID or Data Processing Step ID (e.g., Epoch ID) that the PF PDU belongs to in order to synchronize in case of data processing delay or data forwarding delay.

According to an aspect, the P/F field 1310 may have a length of 1 bit. The P/F field 1310 (via P/F bit) may indicate whether the PF SDU needs to be processed or only to be forwarded directly. For example, due to a limitation of computing or radio channel condition, or due to a demand of service logic, the PF entity of a peer node may have been needed participate in the processing of a previous PF PDU but not needed for the current PF PDU. That is, in some aspects, the peer PF entity may be needed to perform data processing dynamically on demand or on condition instead of processing all the data that pass through the PF sublayer all the time.

Take AI as an example, a UE or a RAN may not participates in AI training in some training epochs due to computing delay. The UE or the RAN may only need to retrieve the PF SDU from the PF PDU and forward the PF SDU, without data processing, to UE application layer or CN. In some aspects, for a specific AI service logic, a UE may cooperate with a CN PF or a DN to perform AI training on PF sublayer in a number of steps or epochs, and during some of the steps or epochs, the RAN may be involved to help UE and CN to process intermediate data on PF sublayer, while in the other steps or epochs the RAN may not be involved.

In some aspects, the XaaS bearer my work in transparent mode, which can be used as a DRB. The P/F bit may indicate to a peer nodes' PF entity to switch between XaaS bearer and DRB. Thus, a peer node's PF entity can be activated or deactivated flexibly via P/F bit to switch between XaaS bearer an DRB. In some aspects, a DRB may be configured with a PF entity which works in transparent mode (TM). For example, if the P/F field 1310 indicates that the data field of a PF PDU need not be processed by the PF sublayer and only needs to be forwarded directly by PF sublayer to upper or lower layer, then the PF sublayer of the XaaS bearer may work in the transparent mode.

FIG. 15 illustrates an embodiment of a table indicating description a P/F field, according to an aspect of the present disclosure. In an aspect, the P/F field may be set to ‘0’ to indicate that data field of the PF PDU may only be forwarded and not processed, thus deactivating PF sublayer into transparent mode. In some aspects, the P/F field may be set to ‘1’ to indicate that data processing on the data field of the PF PDU may be needed.

According to an aspect, the Destination (De) field 1312 may have a length of z bits. The De field 1312 may indicate routing information (e.g., destination address) for a PF entity to transfer the PF PDU, the retrieved or processed PF SDU from the PF PDU, e.g., transfer to one or more of: another PF entity residing in the same node, to another PF entity of peer node, or to upper layer. In some aspects, the PF entity (e.g., an Rx-PF entity) may transfer the De field together with the retrieved or processed PF SDU from the PF PDU. In some aspects, the De field may not be removed, or only parts of information included in the De field may be removed. In some aspects, the De field may be updated when the PF entity performs PF PDU decapsulation, e.g., if the De field indicates the routing information with source routing scheme or Bit Index Explicit Replication (BIER) scheme.

In some aspects, through a XaaS session, data may be processed among different nodes flexibly, e.g., in CN PF unit, in PF sublayer of RAN, in PF sublayer of UE. There may one or more: RANs, UEs, and CN functions participating in a XaaS session, e.g., a XaaS session may go through several RAN nodes and these RAN nodes may cooperate to process the XaaS data in sequence or parallel. In some aspects, a Rx-PF entity within a node (e.g., within a RAN node or UE) may submit, the retrieved or processed PF SDU from a PF PDU to upper layer or transmit to a Tx-PF entity residing in the same node. In some aspects, the different routing actions may be indicated, on the PF PDU, to a peer node. In some aspects, the De field may provide for flexible and correct data forwarding among different nodes. The data forwarding can be unicast transmission or multicast transmission. The De field may further provide for flexible and correct data forwarding among different protocol layers.

According to an aspect, the header 1302 may include routing information e.g., a destination address (the address of one or more of: next hop and the address of the last node finishing the task. For example, a destination address may refer to one or more of: the address of a PF entity residing in a UE, the address of a PF entity residing in a RAN node, and the address of a PF entity residing in a CN node. In some aspects, a globally unique address can be pre-allocated (e.g., by control plane) to each PF entity in the PF sublayer. In some aspects, a routing table may be pre-configured (e.g., by control plane) to each node for a specific task of a XaaS. Based on the destination address and the pre-configured routing table, the current PF entity may know or determine the next hope (which node may be the next hop, e.g., hops to another PF entity residing in the same or different node, or to upper layer).

According to an aspect, the XQFI field 1314 may have a length of t bits. The XQFI field 1314 may indicate an ID of the XaaS QoS flow to which the PF PDU belongs. The XaaS QoS flow ID may indicate to other protocol layer (e.g., the PDCP sublayer) what data forwarding treatment may be suitable to perform. The XaaS QoS flow ID may also indicate to the PF entity (e.g., a PF entity residing in the same node, a PF entity of peer node) what data processing treatment may be suitable to perform.

In some aspects, a PF PDU may include one or more parameters indicated by one or more of: an Xs field, an SN field, a P/F filed, a De field 1312, a XQFI filed 1314, and a data field. In some aspects, a DL PDU header may indicate one or more parameters indicated in an UL PF PDU, and vice versa, as may be appreciated by a person skilled in the art.

According to an aspect, an XaaS bearer may be configured per UE. That is, one XaaS Bearer may serves one dedicated UE and thus deliver (and receive) dedicated PF data packets over radio interface to (and from) one dedicated UE.

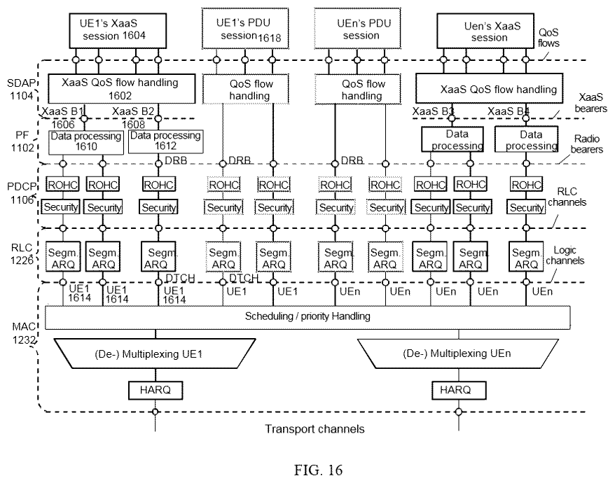

FIG. 16 illustrates an embodiment of a DL layer 2 architecture for XaaS and PDU connectivity service, according to an aspect of the present disclosure. FIG. 16 illustrates one possible DL layer 2 architecture for XaaS (i.e., the solid line boxes) among other possible implementations, as may be appreciated by a person skilled in the art. FIG. 16 further illustrates DL layer 2 architecture for PDU connectivity service (i.e., the dotted line boxes).

According to an aspect, one XaaS bearer per UE may have one or more characteristics. One SDAP entity may be configured for each XaaS session, i.e., SDAP: XaaS session=1:1. For example. SDAP entity 1602 may be configured for UE1's XaaS session 1604. One XaaS session may include one or more XaaS QoS flows.

In some aspects, one XaaS session, e.g., 1604, may be mapped, e.g., by SDAP sublayer 1104, to one or more XaaS data Bearer (XDB) e.g., XaaS B1 1606 and XaaS B2 1608. The mapping of XaaS session to one or more XaaS data bearer may be based on XaaS QoS requirement, e.g., data forwarding treatment requirement and data processing treatment requirement. In some aspects, one XaaS Bearer may transfer data of one or multiple Xaas sessions, i.e., XaaS session: XDB=Q:M.

According to an aspect, one PF entity may be configured for each individual Xaas Bearer, i.e., XDB: PF entity=1:1. For example, PF entity (e.g., data processing 1610) may be configured for XaaS B1 1606 and PF entity 1612 may be configured for XaaS B2 1608.

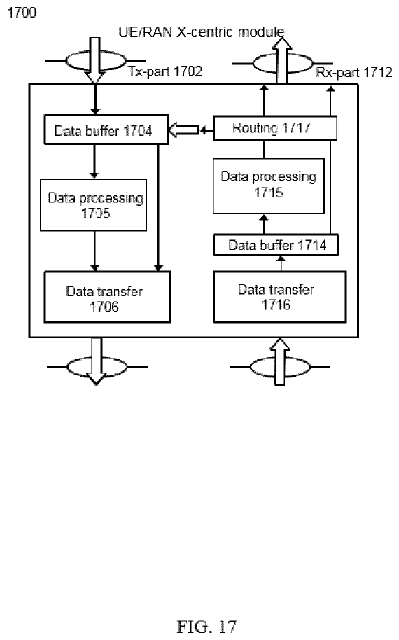

In some aspects, each PF entity (e.g., data processing 1610 and 1612) may perform one or more functions of a Tx-PF entity (e.g., Tx PF entity 702, 802) and a Rx-PF entity (e.g., Rx-PF entity 702, 812) related to an XaaS bearer, as described herein. Accordingly, a PF entity 1610 or 1612 may comprise a transmitting part and a receiving part as illustrated in FIG. 17 and described herein.

In some aspects, an XaaS bearer may be configured with one of a Tx-PF entity and a Rx-PF entity. In some aspects, when necessary, a node's (e.g., a RAN's, a UE's) XaaS bearer may only be configured with a Tx-PF entity and may receive data from the node's another XaaS bearer configured with only a Rx-PF entity via an associated PF sublayer.

Similarly, in some aspects, a node's (e.g., a RAN's, a UE's) XaaS bearer may only be configured with a Rx-PF entity and may deliver data to the node's another XaaS bearer configured with only a Tx-PF entity via the PF sublayers.

According to an aspect, one XaaS Bearer may only serves one dedicated UE, but one UE can be configured with multiple XaaS bearers. For example, each of XaaS B1 1606 and XaaS B2 1608 may be configured with one UE1 1614, whereas UE1 1614 may be configured with XaaS B1 1606 and XaaS B2 1608.

According to an aspect, one XaaS bearer may be mapped to one or multiple DRBs of the same UE, and each DRB may be configured with one PDCP entity. So, data of one PF entity can be mapped to one or multiple PDCP entities configured for the same UE. In some aspects, mapping may be based on XaaS QoS requirement, e.g., data forwarding treatment requirement and data processing treatment requirement. In some aspects, mapping information between an XaaS bearer and a DRB may be configured via dedicated XaaS signalling message or RRC message, e.g., via XSB by XC sublayer or other control plane functions. In some aspects, one DRB may carry data of one or more of XaaS bearers, i.e., XaaS bearer: DRB=M: N.

According to an aspect, DRBs carrying PDU session data and the DRBs carrying XaaS session data can multiplex the radio resources. Thus, data from an XaaS session and a PDU session may mapped to a same MAC sublayer 1232 to multiplex the radio resources. For example, UE1's XaaS session data, UE1's PDU session data, UEn's XaaS session data and UEn's PDU session data may multiplex the radio resources.

According to an aspect, for a UE, the ratio of the number of XaaS session, SDAP entity, XaaS bearer, PF entity, DRB, and PDCP entity, may be as follows: XaaS session: SDAP entity: XaaS bearer: PF entity: DRB: PDCP entity: UE=Q:Q:M:M:N:N.

In some aspects, dedicated type of one or more of: radio bearer, RLC channel, logical channel, transport channel and physical channel, may be defined, reserved, or configured for an XaaS. In some aspects, dedicated physical radio resource (e.g., wireless spectrum) may be allocated to an XaaS.

In some aspects, an XaaS bearer can be configured via dedicated XaaS signalling message or RRC message, e.g., via XSB by XC sublayer or other control plane functions.

In some aspects, if the traffic granularity of an XaaS QoS flow or an XaaS session is same as that of an XaaS bearer, the mapping between the XaaS QoS flow and the XaaS bearer may not be needed and the SDAP entity may not be configured. Accordingly, the XaaS QoS flow or the XaaS session can be mapped to XaaS bearer one-to-one without SDAP entity.

In some aspects, if an XaaS is originated or terminated at a RAN node without the involvement of CN, the SDAP sublayer may not be configured, and the service may be terminated at the PF sublayer between RAN node and UE.

In some aspects, if an XaaS is processed in RAN and CN only, and the UE is not involved, the SDAP sublayer may not be configured (or configured with the absence of DL SDAP header or UL SDAP header).

FIG. 17 illustrates an embodiment of a model of a PF entity comprising a transmitting part (Tx-part) and a receiving part (Rx-part), according to an aspect of the present disclosure. The PF entity 1700 may comprise a Tx-part 1702 and a Rx-part 1712. The Tx-part 1702 may be similar to a Tx-PF entity described herein, and the Rx-part 1712 may be similar to an Rx-PF entity described herein. According to an aspect, each of the Tx-part 1702 and Rx-part 1712 may perform one or more components for performing one or more functions. For example, Tx-part 1702 may comprise a data buffer component 1704, a data processing component 1705 and a data transfer component 1706. The Rx-part 1712 may comprise a routing component 1717, a data processing component 1715, a data buffer component 1714, and a data transfer component 1716. The functions of each component described herein in reference to a PF entity.

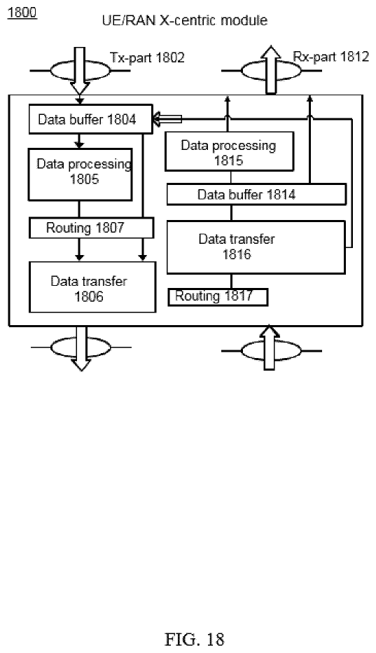

FIG. 18 illustrates another embodiment of a PF entity comprising a Tx-part and a Rx-part, according to an aspect of the present disclosure. The PF entity 1800 may comprise a Tx-part 1802 and a Rx-part 1812. The Tx-part 1802 may be similar to a Tx-PF entity described herein, and the Rx-part 1812 may be similar to an Rx-PF entity described herein. According to an aspect, each of the Tx-part 1802 and Rx-part 1812 may perform one or more components for performing one or more functions. For example, Tx-part 1802 may comprise a data buffer component 1804, a data processing component 1805, a routing component 1807 and a data transfer component 1806. The Rx-part 1812 may comprise a routing component 1817, a data processing component 1815, a data buffer component 1814, and a data transfer component 1816. The functions of each component described herein in reference to a PF entity.

According to an aspect, mapping information between an XaaS QoS flow included in a XaaS session and a XaaS bearer may be known by an SDAP entity if the XaaS QoS flow data is received from a tunnel (e.g., GTP-U tunnel) binding to the XaaS bearer, or received from an XaaS function of CN, e.g., CN XaaS PF. In some aspects, the binding information can be preconfigured when the XaaS QoS flow and XaaS bearer are established.

In some aspects, a CN packet received by the SDAP sublayer (via an SDAP entity) may contain indication information (e.g., in data header) to indicate that the packet is XaaS data rather than connectivity service data. In some aspects, the indication information can be a value of one bit, a Boolean value, a specific QFI (i.e., XQFI), or a specific PDU session ID. Based on the indication information, the SDAP sublayer can decide or determine the mapping information.

In some aspects, the indication information (e.g., a value of one bit, a Boolean value, a specific QFI (i.e., XQFI), or a specific PDU session ID) may be included in an SDAP PDU or in a header of a GTP-U packet, to indicate which XaaS QoS flow the SDAP PDU or the retrieved SDAP SDU from the SDAP PDU may belongs to. In some aspects, performing, by SDAP sublayer, data mapping (UL data mapping on RAN side, or DL data mapping on UE side) may be necessary when an XaaS bearer conveys data of multiple XaaS QoS flows (i.e., multiple XaaS QoS flows may be mapped to an XaaS bearer), e.g., based on a pre-configured XaaS QoS flow and XaaS Bearer mapping rule.

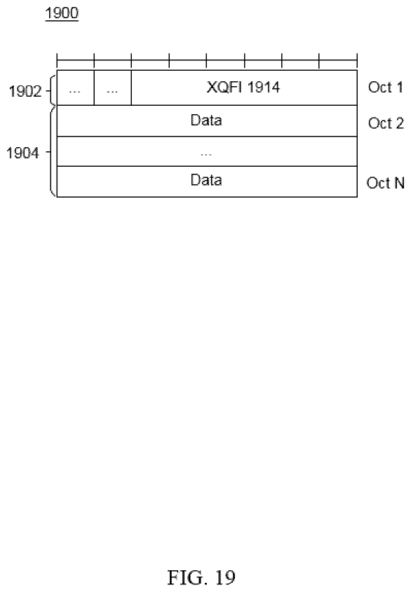

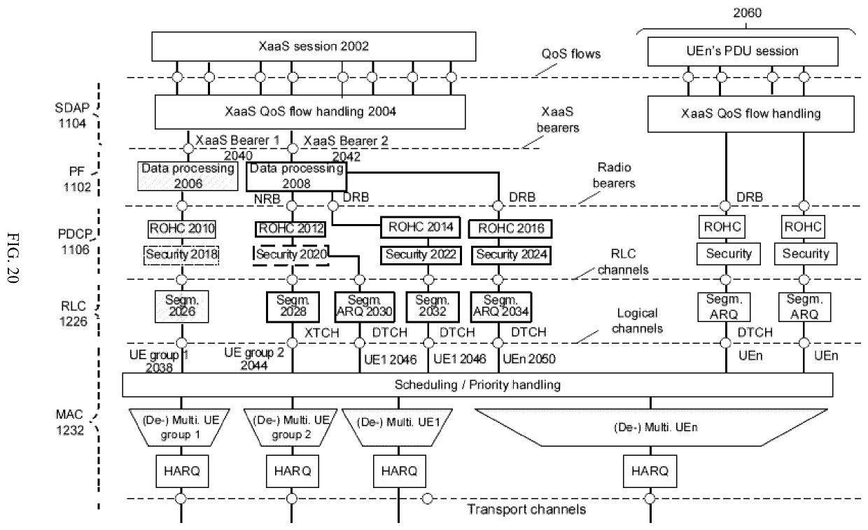

FIG. 19 illustrates an embodiment of an SDAP PDU format with an XQFI field in SDAP header, according to an aspect of the present disclosure. The SDAP PDU format 1900 may comprise a header 1902 and a payload 1904. The header 1902 may comprise a XQFI field 1914 to indicate that the packet is XaaS data.

In some aspects, an XaaS bearer may be configured per UE group. That is, one XaaS Bearer may serve a group of UEs, and deliver (and receive) dedicated PF data packet over radio interface to (and from) the group of UEs. A UE group may comprise one or more participating UEs.

According to an aspect, if an XaaS bearer is configured for a UE group, a first delivery method for transmission of XaaS data packets over radio interface, between a RAN and one or more UEs in the UE group, may involve delivering a single copy of a PF data packet (e.g., a PF PDU) over radio interface to multiple UEs e.g., with broadcast or multicast method.

In some aspects, if an XaaS bearer is configured for a UE group, a second delivery method for transmission of XaaS data packets over radio interface, between a RAN and one or more UEs in the UE group, may involve delivering separate copies of the same PF data packet (e.g., PF PDUs) over radio interface to each of the one or more UEs in the UE group.

In some aspects, if an XaaS bearer is configured for a UE group, the second delivery method for transmission of XaaS data packets over radio interface, between a RAN and one or more UEs in the UE group, may involve delivering different PF data packets (e.g., different data processing results) generated by a PF entity over radio interface to different UEs of the one or more UEs in the UE group.

FIG. 20 illustrates another embodiment of DL layer 2 architecture for XaaS and PDU connectivity service, according to an aspect of the present disclosure. A DL layer 2 architecture for XaaS is illustrated for UE group 1 2038, referred to hashed boxes, PF entity (data processing entity 2006), PDCP entities (ROHC entity 2010 and security entity 2018), and RLC entity (segmentation entity 2026). In some aspects, the security entity 2018 may not be deployed. A second DL layer 2 architecture for XaaS is illustrated for UE group 2 2046, UE1 2046 and UEn 2050, referring to bolded boxes: PF entity (data processing entity 2008), PDCP entities (for UE group 2 2044: ROHC entity 2012, security entity 2020; for UE1 2046: ROHC entity 2012, ROHC entity 2014, security entity 2020, and security entity 2022; for UEn 2050: ROHC entity 2016, and security entity 2024. In some aspects, the security entity 2020 may not be deployed), and RLC entities (for UE group 2 2044: segmentation entity 2028; for UE1 2046: segmentation ARQ entity 2030 and segmentation entity 2032; for UEn 2050: segmentation ARQ entity 2034). A person skilled in the art may appreciate that implementation of DL layer 2 architecture for XaaS is not limited illustrated implementation and that other implementations may also be possible.

FIG. 20 illustrates another embodiment of DL layer 2 architecture 2060 for PDU connectivity service, according to an aspect of the present disclosure. In some aspects, in the first delivery method, where transmission of XaaS data may involve delivering a single copy of a PF data packet (e.g., a PF PDU) over radio interface to multiple UEs e.g., with broadcast or multicast method, mode 1 of an XaaS bearer, used for a UE group (referring to the hashed boxes), may have one or more characteristics. In some aspects, similar to aspects described in reference to FIG. 16, one SDAP entity may be configured for each individual XaaS session, i.e., SDAP: XaaS session=1:1. For example, SDAP entity 2004 (XaaS QoS flow handling entity 2004) may be configured for XaaS session 2002. One XaaS session, e.g., XaaS session 2002, may include one or more XaaS QoS flows.

In some aspects, referring to the first delivery method, similar to aspects described in reference to FIG. 16, one XaaS session 2002 may be mapped, e.g., by SDAP sublayer 1104, to one or more XaaS data Bearer (XaaS bearer 1 2040). The mapping of XaaS session to the one or more XaaS bearer may be based on XaaS QoS requirement, e.g., data forwarding treatment requirement and data processing treatment requirement. In some aspects, one XaaS bearer may transfer data of one or multiple XaaS sessions. XaaS session: XDB=Q:M.

In some aspects, referring to the first delivery method, similar to aspects described in reference to FIG. 16, one PF entity may be configured for each individual XaaS Bearer, i.e., XDB: PF entity=1:1. For example, PF entity (e.g., data processing 2006) may be configured for XaaS bearer 1 2040.

In some aspects, referring to the first delivery method, one XaaS bearer 2040 may serve one UE group including one or more UEs (e.g., UE group 1 2038). In some aspects, one UE can join multiple groups. In some aspects, one UE can be configured with multiple Xaas bearers.

In some aspects, one XaaS bearer may be mapped to one new type of Radio Bear (NRB) to carry the data of XaaS bearer. The NRB may be for point-to-multipoint data transmission between the network and UE, e.g., with multicast or broadcast method.

According to an aspect, the NRB may be configured with one PDCP entity. So, data of one PF entity can be mapped to one PDCP entity configured for a group of UE. In some aspects, mapping may be based on XaaS QoS requirement, e.g., data forwarding treatment requirement and data processing treatment requirement. Mapping information between XaaS bearer and NRB may be configured via dedicated XaaS signalling message or RRC message, e.g., via XSB by XC sublayer or other control plane functions. In some aspects, one NRB may only carry the data of one XaaS bearers. XaaS bearer: NRB=1:1. In some aspects, the DRBs carrying PDU session data and the NRBs carrying XaaS session data can multiplex the radio resources.

Accordingly, for a UE in reference to the first delivery method, the ratio of the number of XaaS session, SDAP entity, XaaS bearer, PF entity, NRB, and NRB PDCP entity maybe: XaaS session:SDAP entity:XaaS bearer:PF entity:NRB:PDCP entity=Q:Q:M:M: M:M.

According to an aspect, the NRB may be configured as a Multicast/Broadcast Services (MBS) Radio Bearer (MRB).

As described herein, the second delivery method of transmitting XaaS data may involve delivering: separate copies of the same PF data packet (e.g., PF PDUs) over radio interface to each UE in a UE group; or delivering different PF data packets (e.g., different data processing results) generated by a PF entity over radio interface to different UEs of the one or more UEs in the UE group.

According to an aspect, in the second delivery method, an XaaS bearer per UE group (e.g., referring to the bold boxes in FIG. 20) may have one or more characteristics. In some aspects, similar to aspects described in reference to FIG. 16, one SDAP entity may be configured for each individual XaaS session, i.e., SDAP: XaaS session=1:1. For example, SDAP entity 2004 (XaaS QoS flow handling entity 2004) may be configured for XaaS session 2002. One XaaS session, XaaS session 2002, may include one or more XaaS QoS flows.

In some aspects, referring to the second delivery method, similar to aspects described in reference to FIG. 16, one XaaS session may be mapped, e.g., by SDAP sublayer, to one or more XaaS data Bearer. The mapping of XaaS session to the one or more XaaS bearer may be based on XaaS QoS requirement. At the same time, one XaaS Bearer may transfer data of one or multiple XaaS sessions, i.e., XaaS session: XDB=Q:M.

In some aspects, referring to the second delivery method, similar to aspects described in reference to FIG. 16, one PF entity may be configured for each individual Xaas Bearer. XDB: PF entity=1:1. For example, PF entity (e.g., data processing 2008) may be configured for XaaS bearer 2 2042.

In some aspects, referring to the second delivery method, one XaaS bearer (e.g., XaaS bearer 2 2042) may serve a group of UEs (e.g., UE group 2 2044, UE1 2046, UEn 2050). In some aspects, one UE may be configured with multiple XaaS bearers.

According to an aspect, one XaaS bearer may be mapped to one or more DRBs, and (optionally) to one or more NRBs. Each DRB or NRB may be configured with one PDCP entity e.g., based on XaaS QoS requirement and UE's radio channel state. So, one PF entity can be mapped to one or more PDCP entities, each of the PDCP entity may be configured for a dedicated UE or a UE group. The mapping between PF entities and PDCP entities and the configuration of PDCP entities, as described herein, may allow for flexible priority and scheduling handling. The mapping of PF entity to one or more PDCP entities may be based on XaaS QoS requirement, e.g., data forwarding treatment requirement and data processing treatment requirement. Mapping information between XaaS bearer and NRB and XaaS bearer and DRB may be configured via dedicated XaaS signalling message or RRC message, e.g., via XSB by XC sublayer or other control plane functions. In some aspects, one DRB/NRB may carry the data of one or more of XaaS bearers, i.e., XaaS bearer: DRB/NRB=M:N.

According to an aspect, XaaS traffic in the second delivery method may split. In some aspects, XaaS traffic may split in PF sublayer 1102, i.e., one PF entity can be configured with multiple PDCP entities. For example, data processing entity 2008 may be configured with multiple PDCP entities (e.g., ROHC entity 2012, ROHC entity 2014 and ROHC entity 2016). The XaaS data carried by one PF entity can be mapped to multiple PDCP entities configured for a dedicated UE or a UE group. For example, separate copies of the same PF data packet (e.g., PF SDUs) carried by one PF entity can be mapped to multiple PDCP entities. As another example, different PF data packets (e.g., different data processing results) generated by a PF entity can be mapped to multiple PDCP entities.

According to an aspect, XaaS Traffic may split in the PDCP sublayer 1106, i.e., one PF entity can be configured with one or multiple PDCP entities, and each PDCP entity may be configured with multiple RLC entities. Referring to FIG. 20, PDCP entity 2020 may be configured with multiple RLC entities (e.g., segmentation entity 2028 and segmentation ARQ entity 2030). In some aspects, when a security entity, e.g., security entity 2020, is not deployed, ROHC entity (e.g., ROHC entity 2012) may be configured with multiple RLC entities (e.g., segmentation entity 2028 and segmentation ARQ entity 2030). For example, separate copies of the same XaaS data packet carried by one PDCP entity (e.g., security entity 2020, ROHC entity 2012) can be mapped to one or more RLCs configured for one or more UEs. As another example, different XaaS data packets carried by one PDCP entity can be mapped to multiple RLC entities.

According to an aspect, the traffic split in PF sublayer 1102 and Traffic split in PDCP sublayer 116 can be integrally deployed. For example, referring to FIG. 20, one PF entity (e.g., data processing entity 2008) can be configured with multiple PDCP entities (e.g., ROHC entity 2012, ROHC entity 2014 and ROHC entity 2016), at the same time, a PDCP entity (e.g., security entity 2020, ROHC entity 2012) may be configured with multiple RLC entities (e.g., segmentation entity 2028 and segmentation ARQ entity 2030).

In some aspects, the one or more of DRBs and NRBs carrying PDU session data and the one or more of DRBs and NRBs carrying XaaS session data may multiplex the radio resources.

According to an aspect, for a UE in the second delivery method the ratio of the number of XaaS session, SDAP entity, XaaS bearer, DRB, DRB PDCP entity, NRB, and NRB PDCP entity may be as follows: XaaS session: SDAP entity:XaaS bearer:PF entity:DRB: DRB PDCP entity:NRB:NRB PDCP entity: UE=Q:Q:M:M:N:N:K:K.

In some aspects, for both the first delivery method and the second delivery method, dedicated type of one or more of: radio bearer, RLC channel (e.g., XaaS Traffic Channel (XTCH) which can be mapped to Downlink Shared Channel DL-SCH; or reuse MBS Traffic Channel MTCH), logical channel, transport channel and physical channel, may be defined, reserved or configured for the XaaS. In some aspects, dedicated physical radio resource (e.g., wireless spectrum) may be allocated to XaaS.

In some aspects, XaaS Bearer Per UE and XaaS Bearer Per UE group can be integrally deployed. For example, some XaaS bearers in the network may be configured to UEs based on the scheme of XaaS Bearer per UE as in FIG. 16, at the same time, some XaaS bearers in the network may be configured to UEs based on the scheme of XaaS Bearer Per UE Group as in FIG. 20. In some aspects, the one or more UEs for which one or more XaaS bearers are configured based on a per UE scheme may be the same as or different from one or more UEs for which one or more XaaS bearers are configured based on a per UE group scheme. In some aspects, if XaaS is originated or terminated at RAN node without the involvement of CN, the SDAP sublayer may not be needed, and the service may be terminated at PF sublayer.

In some aspects, if the traffic granularity of XaaS QoS flow or XaaS session is same as that of the XaaS bearer, the mapping between the XaaS QoS flow and XaaS bearer may not be needed and the SDAP entity may not be configured. Accordingly, the XaaS QoS flow or the XaaS session can be mapped to XaaS bearer one-to-one without SDAP entity.

In some aspects, the PDCP sublayer may not be configured, e.g., for signaling broadcasting via XSB. In some aspects, data split at a PF entity may allow for security protection (e.g., at the granularity of per UE) on PDCP sublayer compared to traditional multicasting/broadcasting.

In some aspects, if the RLC entity is configured to a group of UEs, the RLC entity may work in unacknowledged mode (UM), where the RLC entity may not perform ARQ procedure.

In some aspects, if the RLC is configured to a UE, the RLC can work in unacknowledged mode (UM) or acknowledged mode (AM). RLC entity in acknowledged mode may perform ARQ procedure.

Aspects of the disclosure may provide for one or more of: XaaS session, XaaS QoS flow and XaaS bearer. Some aspects may provide for one or more XaaS QoS parameters comprising data processing treatment parameter(s) and data forwarding parameter(s). One or more aspects described in reference to XaaS session, XaaS QoS flow, XaaS bearer, and XaaS QoS parameters may enable 6G XaaS on CN, RAN and UE side. According to some aspects described herein, a new kind of bearer over the air link may be provided.

According to an aspect, a functional view of a PF may be provided. Aspects may provide for functional design of a Tx-PF entity and Rx-PF entity. Some aspects may provide for a PF PDU format and associated parameters included in a PDU. Aspects described in reference to one or more of: PF entity, PF PDU format and associated parameters may enable RAN to be the data source and data destination, where XaaS data can be originated or terminated at RAN.

According to an aspect, a structural view of a PF entity may be provided, illustrating how the entities of PF sublayer, PDCP sublayer, SDAP sublayer and RLC sublayer may be connected. Some aspects may provide for XaaS bearer configuration design per UE or UE group. Aspect described in reference to structural view of a PF and XaaS bearer configuration design may enable data mapping among XaaS session, XaaS QoS flow, XaaS bearer, DRB and NRB.

According to an aspect, a PF entity is configured in the PF protocol layer at a CNF node, and the function of the PF entity on CNF node are same to the PF entity on the RAN node and the UE. Different PF entities at one or more of CNF node, RAN node and UE can work cooperatively.

According to an aspect, the PF sublayer is deployed at but not limited to one of: on top of the PDCP sublayer, between the SDAP sublayer and the PDCP sublayer, between the PDCP sublayer and the RLC sublayer, between the RLC sublayer and the MAC sublayer, between the MAC sublayer and PHY layer, on top of the SDAP sublayer, on top of a PDU layer, on top of a GTP-U layer, on top of UDP layer, on top of an IP layer, on top of a QUIC layer, on top of a Hypertext Transfer Protocol (HTTP) layer, on top of a segment routing over IPV6 (SRv6) layer, within the PDU layer, within the SDAP sublayer, within the PDCP sublayer, within the RLC sublayer, within the MAC sublayer, within the PHY layer, within the GTP-U layer, within the UDP layer, within the IP layer, within the application layer, within HTTP layer, within SRv6 layer, and within the QUIC layer.

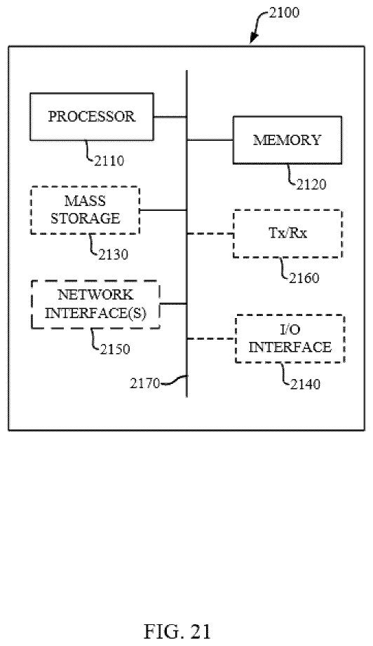

FIG. 21 illustrates an embodiment of an apparatus 2100 that may perform any or all of operations of the above methods and features explicitly or implicitly described herein, according to different aspects of the present disclosure. For example, a computer equipped with network function may be configured as the apparatus 2100. In some aspects, the apparatus 2100 can be a PF (e.g., a Tx-PF, an Rx-PF), a transmitting part, a receiving part, a user equipment, a RAN node, a CN function, or any other entity as the case may be described herein. In some aspect, apparatus 2100 can a device that connects to the network infrastructure over a radio interface, such as a mobile phone, smart phone or other such device that may be classified as user equipment (UE). In some aspects, the apparatus 2100 may be a Machine Type Communications (MTC) device (also referred to as a machine-to-machine (m2m) device), or another such device that may be categorized as a UE despite not providing a direct service to a user. In some aspects, apparatus 2100 may be used to implement one or more aspects described herein. For example, the apparatus 2100 may be configured to perform operations performed by one or more entities and functions described herein.

As shown, the apparatus 2100 may include a processor 2110, such as a Central Processing Unit (CPU) or specialized processors such as a Graphics Processing Unit (GPU) or other such processor unit, memory 2120, non-transitory mass storage 2130, input-output interface 2140, network interface 2150, and a transceiver 2160, all of which are communicatively coupled via bi-directional bus 2170. According to certain aspects, any or all of the depicted elements may be utilized, or only a subset of the elements. Further, apparatus 2100 may contain multiple instances of certain elements, such as multiple processors, memories, or transceivers. Also, elements of the hardware device may be directly coupled to other elements without the bi-directional bus. Additionally, or alternatively to a processor and memory, other electronics, such as integrated circuits, may be employed for performing the required logical operations.

The memory 2120 may include any type of non-transitory memory such as static random-access memory (SRAM), dynamic random-access memory (DRAM), synchronous DRAM (SDRAM), read-only memory (ROM), any combination of such, or the like. The mass storage element 2130 may include any type of non-transitory storage device, such as a solid-state drive, hard disk drive, a magnetic disk drive, an optical disk drive, USB drive, or any computer program product configured to store data and machine executable program code. According to certain aspects, the memory 2120 or mass storage 2130 may have recorded thereon statements and instructions executable by the processor 2110 for performing any of the aforementioned method operations described above.

Aspects of the present disclosure can be implemented using electronics hardware, software, or a combination thereof. In some aspects, this may be is implemented by one or multiple computer processors executing program instructions stored in memory. In some aspects, the invention is implemented partially or fully in hardware, for example using one or more field programmable gate arrays (FPGAs) or application specific integrated circuits (ASICs) to rapidly perform processing operations.

It will be appreciated that, although specific aspects of the technology have been described herein for purposes of illustration, various modifications may be made without departing from the scope of the technology. The specification and drawings are, accordingly, to be regarded simply as an illustration of the invention as defined by the appended claims, and are contemplated to cover all modifications, variations, combinations, or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding aspects, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disc read-only memory (CD-ROM), USB flash disk, or a removable hard disk. The software product includes a number of instructions that enable a computer device (personal computer, server, or network device) to execute the methods provided in the aspects of the present invention. For example, such an execution may correspond to a simulation of the logical operations as described herein. The software product may additionally or alternatively include a number of instructions that enable a computer device to execute operations for configuring or programming a digital logic apparatus in accordance with aspects of the present invention.

Although the present invention has been described with reference to specific features and aspects thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

1. A method of providing a network service, the method comprising:
receiving, by a first device, from a second device, at least one protocol data unit (PDU) containing at least one service data unit (SDU) associated with the network service;
retrieving, by the first device, the at least one SDU from the at least one PDU; and
processing, by the first device, the at least one SDU to obtain a processed version of the at least one SDU;
constructing, by the first device, at least one additional PDU comprising the processed version of the at least one SDU; and
sending, by the first device to the second device, the at least one additional PDU.

2. The method of claim 1, wherein retrieving the at least one SDU, processing the at least one SDU, and constructing the at least one additional PDU are performed at the first device, by a processing function (PF) at the first device.

3. The method of claim 1, wherein receiving the at least one PDU at the first device includes receiving the at least one PDU via at least one network service data bearer (XDB) established between the first device and the second device, the at least one XDB being configured for the network service.

4. The method of claim 2, wherein a communication network in which the first device and the second device are deployed includes a PF protocol sublayer, the retrieving of the at least one SDU, the processing of the at least one SDU and the constructing of the at least one additional PDU at the first device being performed in the PF protocol sublayer, by the PF at the first device.

5. The method of claim 4, wherein:
the second device includes a PF deployed at the second device in the PF protocol sublayer; and
receiving, from the second device, the at least one PDU includes receiving the at least one PDU from the PF deployed at the second device via at least one network service data bearer (XDB) established between the first device and the second device.

6. The method of claim 1, wherein the network service includes one or more of: data analytics, artificial intelligence (AI) training, AI inference, data privacy protection, data sanitization, data processing, data management, data cleaning, data normalization, useless data filtering, data feature engineering, data compression, data embedding, data representation learning, and data feature extraction.

7. The method of claim 4, wherein the communication network further includes a packet data convergence protocol (PDCP) sublayer, the PF protocol sublayer being deployed on top of the PDCP sublayer.

8. The method of claim 5, wherein the at least one XDB is configured to serve a UE only, the at least one XDB also configured to deliver to the UE and to receive from the UE, PF protocol sublayer PDUs over a radio interface.

9. The method of claim 5, wherein the at least one XDB is configured for a group of UEs including a UE, to deliver at least one PF protocol sublayer PDU to the group of UEs and to receive the at least one PF protocol sublayer PDU from the group of UEs.

10. The method of claim 4, wherein the PF protocol sublayer comprises a PF entity, the PF entity comprising one or more of: a data buffer component, a data processing component, a routing component, and a data transfer component.

11. The method of claim 10, wherein the PF entity performs one or more of:
receiving or delivering at least one PF SDU from or to:
an upper layer;
a lower layer; and
another PF entity;
submitting or receiving at least one PF PDU to or from:
the lower layer, or
the another PF entity.

12. The method of claim 11, wherein the at least one PF PDU comprises one or more of: a packet header and a PF SDU.

13. The method of claim 12, wherein one PF PDU of the at least one PF PDU comprises a packet header indicating one or more of: a type of the network service the one PF PDU belongs to, a sequence number of the one PF PDU, an indication to further process the one PF SDU contained in the one PF PDU, a type of data processing on the one PF SDU contained in the one PF PDU, an indication to forward a PF SDU contained in the one PF PDU directly, a routing information, a network service QFI identifying the QoS flow to which the one PF PDU belongs.

14. The method of claim 13, wherein the type of data processing includes one or more methods of: data analytics, AI training, AI inference, data privacy protection, data sanitization, data processing, data management, data cleaning, data normalization, useless data filtering, data feature engineering, data compression, data embedding, data representation learning, and data feature extraction.

15. The method of claim 13, wherein:
the routing information indicates a destination for a PF entity receiving the PF PDU to transfer the data to, and the data includes one or more of: the PF SDU contained in the PF PDU, the processed version of the PF SDU contained in the PF PDU, a constructed PF PDU comprising the PF SDU contained in the PF PDU, or a constructed PF PDU comprising the processed version of the PF SDU contained in the PF PDU; and
the destination is one or more of: the PF entity, another PF entity residing in the same node with the PF entity, another PF entity of a peer node, an entity of an upper layer, or an entity of a lower layer.

16. The method of claim 3, wherein
a dedicated type of one or more of: an associated data radio bearer (DRB), an associated radio link control (RLC) channel, a logical channel, a transport channel and a physical channel is defined, reserved or configured for the at least one XDB of the network service; and
a dedicated physical radio resource is allocated to the at least one XDB of the network service.

17. The method of claim 16, wherein the at least one XDB and the associated DRB are configured with a same medium access control (MAC) entity of an associated MAC sublayer to multiplex related radio resources.

18. The method of claim 16, wherein the at least one XDB is configured via a dedicated signalling message for the network service or a radio resource control (RRC) message for the network service.

19. The method of claim 18, wherein the dedicated signaling message for the network service is sent via a signaling radio bearer between the RAN node and the UE by a control entity of a control protocol layer above an associated PDCP sublayer.

20. An apparatus, comprising:
a memory configured to store instructions;
a processor configured to execute the instructions stored in the memory, and when the instructions stored in the memory are executed, the processor is configured to:
receive, by a first device, from a second device, at least one protocol data unit (PDU) containing at least one service data unit (SDU) associated with the network service;
retrieve, by the first device, the at least one SDU from the at least one PDU; and
process, by the first device, the at least one SDU to obtain a processed version of the at least one SDU;
construct, by the first device, at least one additional PDU comprising the processed version of the at least one SDU; and
send, by the first device to the second device, the at least one additional PDU.
